(19) United States
(12) Patent Application Publication
(10) Pub. No.: US 2026/0194733 A1
(43) Pub. Date: Jul. 9, 2026

(54) CAMERA OPTICAL LENS

(71) Applicant: Changzhou AAC Raytech Optronics Co., Ltd., Changzhou City (CN)

(72) Inventors: Yuyi Liu, Changzhou (CN); Shunda Zhou, Changzhou (CN)

(21) Appl. No.: 19/342,638

(22) Filed: Sep. 28, 2025

Related U.S. Application Data
(63) Continuation of application No. PCT/CN2025/070398, filed on Jan. 3, 2025.

(51) Int. Cl. G02B 13/00; G02B 9/64

(52) U.S. Cl. CPC G02B 13/0045; G02B 9/64

(57) ABSTRACT

Provided is a camera optical lens, including eight lenses from an object side to an image side: first lens through eighth lens. A focal length of the third lens is f3, a focal length of the fourth lens is f4, a focal length of the seventh lens is f7, a focal length of the eighth lens is f8, a central curvature radius of an image side surface of the seventh lens is R14, a central curvature radius of an object side surface of the eighth lens is R15, a total track length of the camera optical lens is TTL, and an on-axis distance from an image side surface of the eighth lens to an image plane is BF, and following relational expressions are satisfied: 2.00≤f3/f4≤8.00; −0.40≤f7/R14−f8/R15≤−0.10; and 0.12≤BF/TTL≤0.15. The camera optical lens has good optical performance and meets design requirements of ultra-thin and wide-angle.

### TECHNICAL FIELD

The present disclosure relates to the field of optical lenses, and in particular, to a camera optical lens suitable for handheld terminal devices such as smart phones and digital cameras, and camera apparatus such as monitors and PC lenses.

### BACKGROUND

In recent years, with the rise of various smart devices, the demand for a miniaturized camera optical lens has gradually increased. In addition, since the pixel size of a photosensitive device is reduced, and the current electronic product has a development trend towards having good functions and an appearance of thin, light and portable, the miniaturized camera optical lens having good imaging quality has become a mainstream in the current market. In order to obtain better imaging quality, a multi-lens structure is mostly adopted. In addition, with the development of technology and the increase of diversified requirements of users, under the conditions that a pixel area of the photosensitive device continues to reduce and the requirement on the imaging quality of the system are continuously improving, an eight-lens structure has been gradually adopted in the lens design. There is an urgent need for a wide-angle camera lens having excellent optical characteristics with small volume and fully corrected aberrations.

### SUMMARY

In view of the above problems, a main object of the present disclosure is to provide a camera optical lens, which has good optical performance and meets design requirements of ultra-thin and wide-angle.

In order to achieve the above object, an embodiment of the present disclosure provides a camera optical lens, including eight lenses from an object side to an image side: a first lens having positive refractive power, a second lens having negative refractive power, a third lens having positive refractive power, a fourth lens having positive refractive power, a fifth lens having negative refractive power, a sixth lens having negative refractive power, a seventh lens having positive refractive power, and an eighth lens having negative refractive power. A focal length of the third lens is f3, a focal length of the fourth lens is f4, a focal length of the seventh lens is f7, a focal length of the eighth lens is f8, a central curvature radius of an image side surface of the seventh lens is R14, a central curvature radius of an object side surface of the eighth lens is R15, a total track length of the camera optical lens is TTL, and an on-axis distance from an image side surface of the eighth lens to an image plane is BF, and following relational expressions are satisfied: 2.00≤f3/f4≤8.00; −0.40≤f7/R14−f8/R15≤−0.10; and 0.12≤BF/TTL≤0.15.

As an improvement, a focal length of the camera optical lens is f, and a focal length of the second lens is f2, and a following relational expression is satisfied: −5.50≤f2/f≤−3.50.

As an improvement, a focal length of the fifth lens is f5, a central curvature radius of an object side surface of the fifth lens is R9, a central curvature radius of an image side surface of the fifth lens is R10, and an on-axis thickness of the fifth lens is d9, and a following relational expression is satisfied: 0.06≤f5*d9/(R9−R10)≤0.13.

As an improvement, an Abbe number of the first lens is v1, and a following relational expression is satisfied: 60.00≤v1≤82.00.

As an improvement, an object side surface of the first lens is convex in a paraxial region, and an image side surface of the first lens is concave in the paraxial region. A focal length of the camera optical lens is f, a focal length of the first lens is f1, a central curvature radius of the object side surface of the first lens is R1, a central curvature radius of the image side surface of the first lens is R2, and an on-axis thickness of the first lens is d1, and following relational expressions are satisfied: 1.07≤f1/f≤1.20; −1.85≤(R1+R2)/(R1−R2)≤−1.77; and 0.130≤d1/TTL≤0.134.

As an improvement, an object side surface of the second lens is convex in a paraxial region, and an image side surface of the second lens is concave in the paraxial region. A focal length of the camera optical lens is f, a central curvature radius of the object side surface of the second lens is R3, a central curvature radius of the image side surface of the second lens is R4, and an on-axis thickness of the second lens is d3, and following relational expressions are satisfied: 3.45≤(R3+R4)/(R3−R4)≤5.00; and 0.025≤d3/TTL≤0.034.

As an improvement, an object side surface of the third lens is convex in the paraxial region, and an image side surface of the third lens is concave in the paraxial region. A focal length of the camera optical lens is f, a central curvature radius of the object side surface of the third lens is R5, a central curvature radius of the image side surface of the third lens is R6, and an on-axis thickness of the third lens is d5, and following relational expressions are satisfied: 9.24≤f3/f≤28.59; −31.28≤(R5+R6)/(R5−R6)≤−10.24; and 0.026≤d5/TTL≤0.038.

As an improvement, an object side surface of the fourth lens is concave in a paraxial region, and an image side surface of the fourth lens is convex in the paraxial region. A focal length of the camera optical lens is f, a central curvature radius of the object side surface of the fourth lens is R7, a central curvature radius of the image side surface of the fourth lens is R8, and an on-axis thickness of the fourth lens is d7, and following relational expressions are satisfied: 3.57≤f4/f≤4.61; 1.13≤(R7+R8)/(R7−R8)≤1.56; and 0.075≤d7/TTL≤0.082.

As an improvement, an object side surface of the fifth lens is concave in a paraxial region, and an image side surface of the fifth lens is concave in the paraxial region. A focal length of the camera optical lens is f, a focal length of the fifth lens is f5, a central curvature radius of the object side surface of the fifth lens is R9, a central curvature radius of the image side surface of the fifth lens is R10, and an on-axis thickness of the fifth lens is d9, and following relational expressions are satisfied: −4.88≤f5/f≤−4.18; −0.70≤(R9+R10)/(R9−R10)≤−0.40; and 0.033≤d9/TTL≤0.047.

As an improvement, an object side surface of the sixth lens is convex in a paraxial region, and an image side surface of the sixth lens is concave in the paraxial region. A focal length of the camera optical lens is f, a focal length of the sixth lens is f6, a central curvature radius of the object side surface of the sixth lens is R11, a central curvature radius of the image side surface of the sixth lens is R12, and an on-axis thickness of the sixth lens is d11, and following relational expressions are satisfied: −17.28≤f6/f≤−9.73; 4.40≤(R11+R12)/(R11−R12)≤6.75; and 0.065≤d11/TTL≤0.069.

As an improvement, an object side surface of the seventh lens is convex in a paraxial region, and an image side surface of the seventh lens is concave in the paraxial region. A focal length of the camera optical lens is f, a central curvature radius of the object side surface of the seventh lens is R13, and an on-axis thickness of the seventh lens is d13, and following relational expressions are satisfied: 0.99≤f7/f≤1.12; −2.47≤(R13+R14)/≤−2.25; and 0.062≤d13/TTL≤0.068.

As an improvement, an object side surface of the eighth lens is concave in a paraxial region, and an image side surface of the eighth lens is concave in the paraxial region. A focal length of the camera optical lens is f, a central curvature radius of the image side surface of the eighth lens is R16, and an on-axis thickness of the eighth lens is d15, and following relational expressions are satisfied: −0.83≤f8/f≤−0.64; −0.64≤(R15+R16)/≤−0.48; and 0.048≤d15/TTL≤0.068.

As an improvement, the first lens is made of glass.

The present disclosure has the following beneficial effects: the camera optical lens according to the present disclosure has excellent optical characteristics, as well as wide-angle and ultra-thin characteristics, and is particularly suitable for a mobile phone camera lens assembly and a WEB camera lens composed of camera elements such as CCD and CMOS with high resolution.

### BRIEF DESCRIPTION OF DRAWINGS

In order to better illustrate the technical solutions in embodiments of the present disclosure, the drawings used in the description of the embodiments will be briefly described below. It is appreciated that, the drawings in the following description are only some embodiments of the present disclosure, and for those skilled in the art, other drawings may also be obtained according to these drawings without creative effort.

FIG. 1 is a schematic structural diagram of a camera optical lens according to a first embodiment of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a schematic structural diagram of a camera optical lens according to a second embodiment of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a schematic structural diagram of a camera optical lens according to a third embodiment of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a schematic structural diagram of a camera optical lens according to a fourth embodiment of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a schematic structural diagram of a camera optical lens according to a fifth embodiment of the present disclosure;

FIG. 18 is a schematic diagram of axial aberration of the camera optical lens shown in FIG. 17;

FIG. 19 is a schematic diagram of lateral color of the camera optical lens shown in FIG. 17;

FIG. 20 is a schematic diagram of field curvature and distortion of the camera optical lens shown in FIG. 17;

FIG. 21 is a schematic structural diagram of a camera optical lens according to a comparative embodiment of the present disclosure;

FIG. 22 is a schematic diagram of axial aberration of the camera optical lens shown in FIG. 21;

FIG. 23 is a schematic diagram of lateral color of the camera optical lens shown in FIG. 21; and

FIG. 24 is a schematic diagram of field curvature and distortion of the camera optical lens shown in FIG. 21.

### DESCRIPTION OF EMBODIMENTS

In order to better illustrate objectives, technical solutions, and advantages of embodiments of the present disclosure, the technical solutions in the embodiments of the present disclosure are clearly and completely described in details with reference to the drawings. Those of ordinary skill in the art will appreciate that in various embodiments of the present disclosure, numerous technical details are set forth for the reader to better understand the present disclosure. However, even without these technical details and various variations and modifications based on the following embodiments, the technical solutions claimed in the present disclosure can still be implemented.

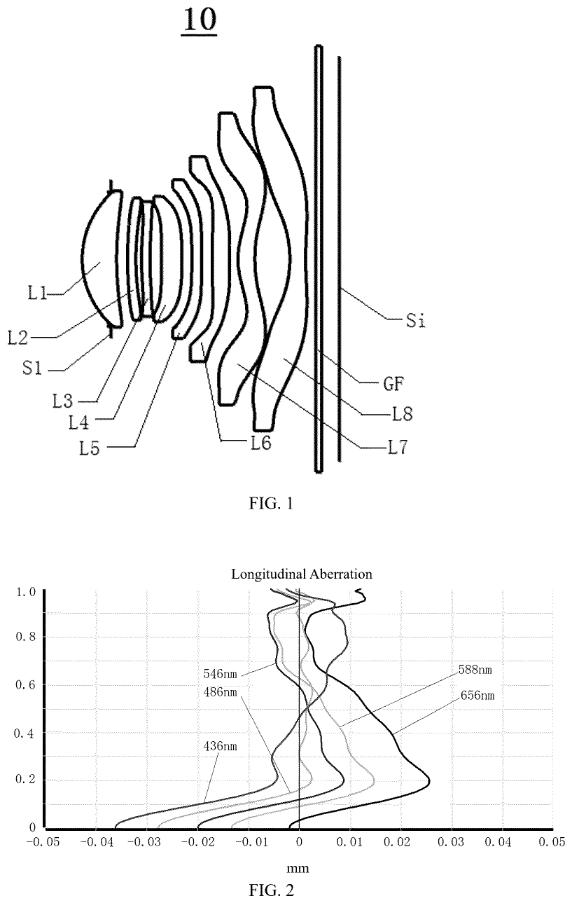

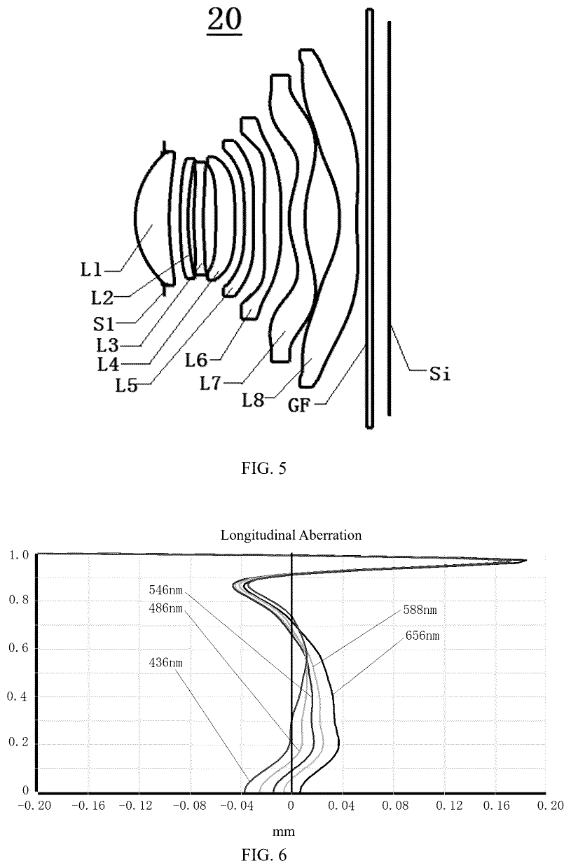

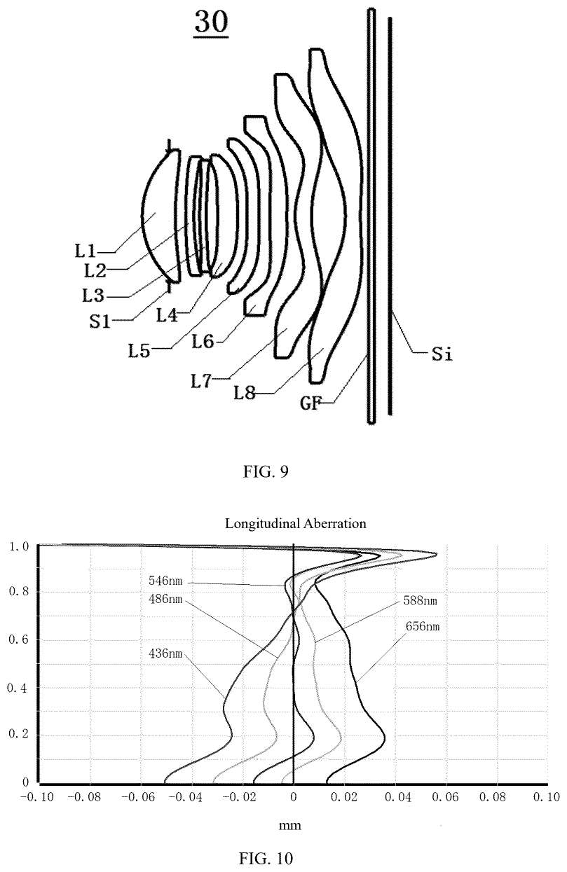

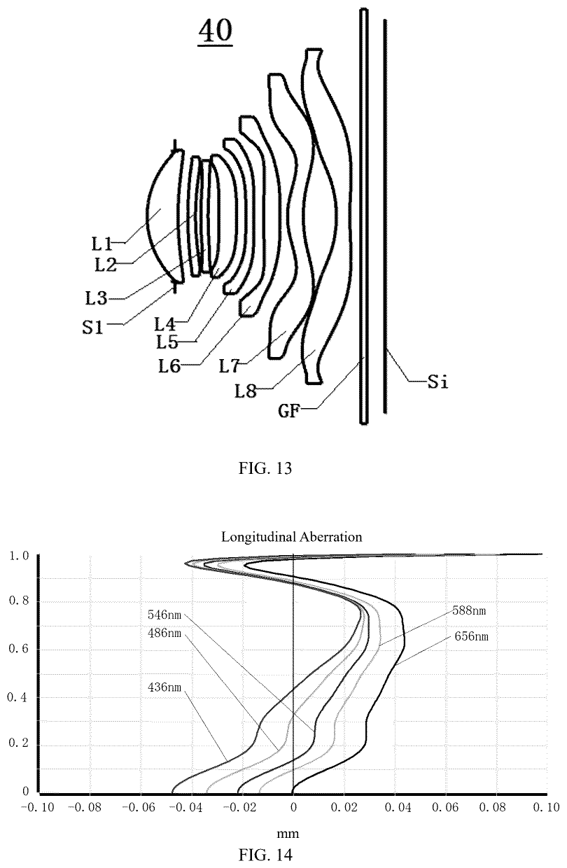

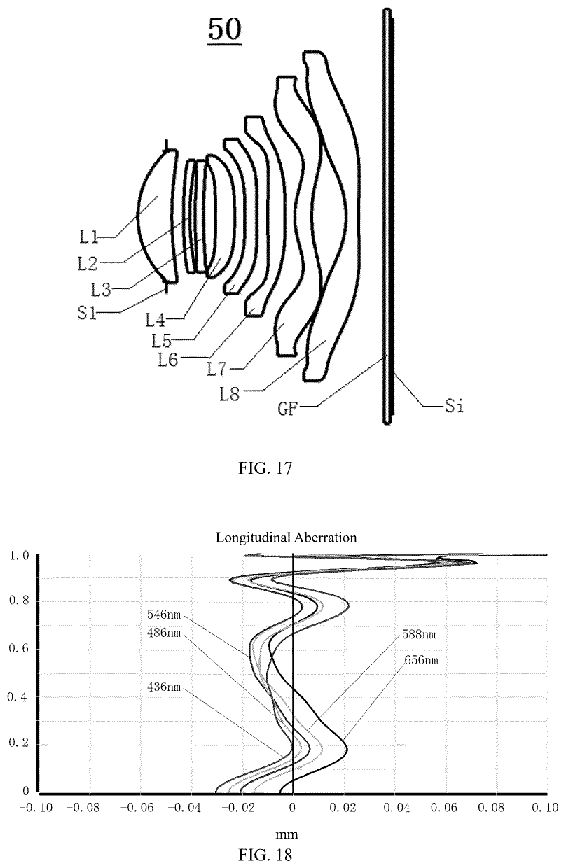

Referring to the drawings, embodiments of the present disclosure provides a camera optical lens 10, 20, 30, 40 and 50. FIG. 1, FIG. 5, FIG. 9, FIG. 13, and FIG. 17 show the camera optical lens 10, 20, 30, 40 and 50 according to the present disclosure, and the camera optical lens 10, 20, 30, 40 and 50 includes eight lenses. In an example, the camera optical lens includes from an object side to an image side: an aperture S1, a first lens L1, a second lens L2, a third lens L3, a fourth lens L4, a fifth lens L5, a sixth lens L6, a seventh lens L7, and an eighth lens L8. An optical element such as a grating filter GF may be provided between the eighth lens L8 and an image plane Si.

The first lens L1 is made of glass, the second lens L2 is made of plastic, the third lens L3 is made of plastic, the fourth lens L4 is made of plastic, the fifth lens L5 is made of plastic, the sixth lens L6 is made of plastic, the seventh lens L7 is made of plastic, and the eighth lens L8 is made of plastic. Each lens may also be made of other materials.

A focal length of the third lens L3 is defined as f3, and a focal length of the fourth lens L4 is defined as f4, and the following relational expression is satisfied: 2.00≤f3/f4≤8.00. Within the range of the relational expression, it is beneficial to reasonably distribute the optical focal length of the distribution system of the camera optical lens, so that the camera optical lens has better imaging quality and lower sensitivity.

A focal length of the seventh lens L7 is defined as f7, a focal length of the eighth lens L8 is defined as f8, a central curvature radius of the image side surface of the seventh lens L7 is defined as R14, and a central curvature radius of the object side surface of the eighth lens L8 is defined as R15, and the following relational expression is satisfied: −0.40≤f7/R14−f8/R15≤−0.10. Within the range of the relational expression, the deflection degree of the edge field of view in the seventh lens L7 and the eighth lens L8 can be effectively controlled, thereby reducing the sensitivity of the entire camera optical lens.

A total track length of the camera optical lens is defined as TTL, and an on-axis distance from the image side surface of the eighth lens L8 to the image plane is BF, and the following relational expression is satisfied: 0.12≤BF/TTL≤0.15. Within the range of the relational expression, it is beneficial to achieve miniaturization of the camera optical lens while having a longer back focal length, thereby facilitating the assembly of the camera optical lens. Further, the total length of the optical system of the camera optical lens may be effectively controlled within the range of the relational expression.

When the above relational expressions are satisfied, the camera optical lens 10, 20, 30, 40 and 50 has good optical performance and can satisfy the design requirements of large aperture, wide-angle and ultra-thin. According to the characteristics of the camera optical lens 10, 20, 30, 40 and 50, the camera optical lens 10, 20, 30, 40 and 50 are particularly suitable for the mobile phone camera lens assembly and the WEB camera lens composed of camera elements such as CCD and CMOS with high resolution.

Based on the above relational expressions and the achievable functions, the characteristics of each lens are further defined as follows.

A focal length of the camera optical lens is defined as f, and a focal length of the second lens L2 is defined as f2, and the following relational expression is satisfied: −5.50≤f2/f≤−3.50. This relational expression specifies the ratio of the negative refractive power of the second lens L2 to the overall focal length. Within the specified range, the second lens L2 has appropriate negative refractive power, which is beneficial to reducing system aberrations, and is beneficial to the development of the camera optical lens towards ultra-thin and wide-angle, thereby enabling the camera optical lens to have better imaging quality and lower sensitivity.

A focal length of the fifth lens L5 is defined as f5, a central curvature radius of the object side surface of the fifth lens L5 is defined as R9, a central curvature radius of the image side surface of the fifth lens L5 is defined as R10, and an on-axis thickness of the fifth lens L5 is defined as d9, and the following relational expression is satisfied: 0.06≤f5*d9/(R9−R10)≤0.13. Within the range of the relational expression, it helps to control the lens shape of the fifth lens L5, thereby facilitating molding.

An Abbe number of the first lens L1 is defined as v1, and the following relational expression is satisfied: 60.00≤v1≤82.00. This relational expression specifies the Abbe number of the first lens L1. Within the range of the relational expression, material properties can be effectively distributed, thereby effectively correcting the chromatic aberration, and making the chromatic aberration |LC|≤4.0 μm.

An object side surface of the first lens L1 is convex in a paraxial region, and an image side surface of the first lens L1 is concave in the paraxial region. The first lens L1 has a positive refractive power.

The focal length of the first lens L1 is f1, and the following relational expression is satisfied: 1.07≤f1/f≤1.20. The system has better imaging quality and lower sensitivity through reasonable distribution of the refractive power.

A central curvature radius of the object side surface of the first lens L1 is R1, and a central curvature radius of the image side surface of the first lens L1 is R2, and the following relational expression is satisfied: −1.85≤(R1+R2)/(R1−R2)≤−1.77. This relational expression specifies the shape of the first lens L1, and thus is beneficial to the molding of the first lens L1. Within the range specified by the relational expression, the deflection degree of light passing through the lens can be reduced, thereby effectively reducing the aberrations.

An on-axis thickness of the first lens L1 is d1, and the following relational expression is satisfied: 0.130≤d1/TTL≤0.134. Within the range of the relational expression, it is beneficial to achieve ultra-thin property.

An object side surface of the second lens L2 is convex in a paraxial region, and an image side surface of the second lens L2 is concave in the paraxial region. The second lens L2 has a negative refractive power.

A central curvature radius of the object side surface of the second lens L2 is R3, and a central curvature radius of the image side surface of the second lens L2 is R4, and the following relational expression is satisfied: 3.45≤(R3+R4)/(R3−R4)≤5.00. This relational expression specifies the shape of the second lens L2. Within the range, as the lens develops towards ultra-thin and wide-angle, it is conducive to correcting on-axis chromatic aberrations.

An on-axis thickness of the second lens L2 is d3, and the following relational expression is satisfied: 0.025≤d3/TTL≤0.034. Within the range of relational expression, it is beneficial to achieve ultra-thin property.

An object side surface of the third lens L3 is convex in a paraxial region, and an image side surface of the third lens L3 is concave in the paraxial region. The third lens L3 has a positive refractive power. The object side surface and the image side surface of the third lens L3 may also be configured with other concave and convex arrangements.

A focal length of the camera optical lens 10 is f, and a focal length of the third lens L3 is f3, and the following relational expression is satisfied: 9.24≤f3/f≤28.59. The system has better imaging quality and lower sensitivity through the reasonable distribution of refractive power.

A central curvature radius of the object side surface of the third lens L3 is R5, and a central curvature radius of the image side surface of the third lens L3 is R6, and the following relational expression is satisfied: −31.28≤(R5+R6)/(R5−R6)≤−10.24. This relational expression defines the shape of the third lens L3, and thus is beneficial to the molding of the third lens L3. Within the range specified by the relational expression, the deflection degree of light passing through the lens can be reduced, thereby effectively reducing the aberrations.

An on-axis thickness of the third lens L3 is d5, and the total track length of the camera optical lens 10 is TTL, and the following relational expression is satisfied: 0.026≤d5/TTL≤0.038. Within the range of relational expression, it is beneficial to achieve ultra-thin property.

An object side surface of the fourth lens L4 is convex in a paraxial region, and an image side surface of the fourth lens L4 is concave in the paraxial region. The fourth lens L4 has a positive refractive power.

A focal length of the camera optical lens 10 is f, and a focal length of the fourth lens L4 is f4, and the following relational expression is satisfied: 3.57≤f4/f≤4.61. The system has better imaging quality and lower sensitivity through the reasonable distribution of refractive power.

A central curvature radius of the object side surface of the fourth lens L4 is R7, and a central curvature radius of the image side surface of the fourth lens L4 is R8, and the following relational expression is satisfied: 1.13≤(R7+R8)/(R7−R8)≤1.56. This relational expression specifies the shape of the fourth lens L4. Within the range of the relational expression, it is beneficial to correct the problems such as the aberration of off-axis angles with the development of the ultra-thin and wide-angle.

An on-axis thickness of the fourth lens L4 is d7, and the following relational expression is satisfied: 0.075≤d7/TTL≤0.082. Within the range of relational expression, it is beneficial to achieve ultra-thin property.

An object side surface of the fifth lens L5 is concave in a paraxial region, and an image side surface of the fifth lens L5 is concave in the paraxial region. The fifth lens L5 has a negative refractive power.

A focal length of the camera optical lens 10 is f, and a focal length of the fifth lens L5 is f5, and the following relational expression is satisfied: −4.88≤f5/f3-4.18. The limitation of the fifth lens L5 may effectively make a light angle of the camera optical lens 10 smooth, thereby reducing the tolerance sensitivity.

A central curvature radius of the object side surface of the fifth lens L5 is R9, and a central curvature radius of the image side surface of the fifth lens L5 is R10, and the following relational expression is satisfied: −0.70≤(R9+R10)/(R9−R10)≤−0.40. This relational expression specifies the shape of the fifth lens L5. Within the range of the relational expression, it is beneficial to correct the problems such as the aberration of off-axis angles with the development of the ultra-thin and wide-angle.

An on-axis thickness of the fifth lens L5 is d9, and a total track length of the camera optical lens 10 is TTL, and the following relational expression is satisfied: 0.033≤d9/TTL≤0.047. Within the range of relational expression, it is beneficial to achieve ultra-thin property.

An object side surface of the sixth lens L6 is convex in a paraxial region, and an image side surface of the sixth lens L6 is concave in the paraxial region. The sixth lens L6 has a negative refractive power.

A focal length of the sixth lens L6 is f6, and the following relational expression is satisfied: −17.28≤f6/f≤−9.73. The system has better imaging quality and lower sensitivity through reasonable distribution of the refractive power.

A central curvature radius of the object side surface of the sixth lens L6 is R11, and a central curvature radius of the image side surface of the sixth lens L6 is R12, and the following relational expression is satisfied: 4.40≤(R11+R12)/≤6.75. This relational expression specifies the shape of the sixth lens L6. Within the range specified by the relational expression, it is beneficial to correct the problems such as the aberration of off-axis angles with the development of the ultra-thin and wide-angle.

An on-axis thickness of the sixth lens L6 is d11, and the following relational expression is satisfied: 0.065≤d11/TTL≤0.069. Within the range of relational expression, it is beneficial to achieve ultra-thin property.

An object side surface of the seventh lens L7 is convex in a paraxial region, and an image side surface of the seventh lens L7 is concave in the paraxial region. The seventh lens L7 has a positive refractive power.

A focal length of the camera optical lens 10 is f, and a focal length of the seventh lens L7 is f7, and the following relational expression is satisfied: 0.99≤f7/f≤1.12. The system has better imaging quality and lower sensitivity through the reasonable distribution of refractive power.

A central curvature radius of the object side surface of the seventh lens L7 is defined as R13, and a central curvature radius of the image side surface of the seventh lens L7 is R14, and the following relational expression is satisfied: −2.47≤(R13+R14)/≤−2.25. This relational expression specifies the shape of the seventh lens L7. Within the range specified by the relational expression, it is beneficial to correct the problems such as the aberration of off-axis angles with the development of the ultra-thin and wide-angle.

A thickness on-axis of the seventh lens L7 is d13, and the following relational expression is satisfied: 0.062≤d13/TTL≤0.068. Within the range of relational expression, it is beneficial to achieve ultra-thin property.

An object side surface of the eighth lens L8 is concave in a paraxial region, and an image side surface of the eighth lens L8 is concave in the paraxial region. The eighth lens L8 has a negative refractive power.

A focal length of the camera optical lens 10 is f, and a focal length of the eighth lens L8 is f8, and the following relational expression is satisfied: −0.83≤f8/f≤−0.64. The system has better imaging quality and lower sensitivity through the reasonable distribution of refractive power.

A central curvature radius of the image side surface of the eighth lens L8 is defined as R16, and a central curvature radius of the object side surface of the eighth lens L8 is defined as R15, and the following relational expression is satisfied: −0.64≤(R15+R16)/≤−0.48. This relational expression specifies the shape of the eighth lens. Within the range specified by the relational expression, it is beneficial to correct the problems such as the aberration of off-axis angles with the development of the ultra-thin and wide-angle.

An on-axis thickness of the eighth lens L8 is d15, and the following relational expression is satisfied: 0.048≤d15/TTL≤0.068. Within the range of relational expression, it is beneficial to achieve ultra-thin property.

An image height at the 1.0 field of view of the camera optical lens 10 is IH, and the following relational expression is satisfied: TTL/IH≤1.42, which is beneficial to achieving ultra-thin property. Optionally, TTL/IH≤1.36.

A field of view FOV at the 1.0 field of view of the camera optical lens 10 is greater than or equal to 52.71°, thereby achieving wide-angle property. Optionally, the field of view FOV at the 1.0 field of view of the camera optical lens 10 is greater than or equal to 66.50°.

The F-number FNO of the camera optical lens 10 is less than or equal to 1.59, thereby achieving large aperture and good imaging performance of the camera optical lens.

The total track length TTL of the camera optical lens 10 is less than or equal to 9.04 mm, which is beneficial for achieving ultra-thin property.

The camera optical lens of the present disclosure will be described below with examples. The reference signs recited in each example are shown below. The units of the focal length, the on-axis distance, the central curvature radius, the on-axis thickness, the inflection point position, and the arrest point position are mm.

TTL: a total track length (an on-axis distance from the object side surface of the first lens L1 to the image surface Si), in mm.

F-number FNO: a ratio of the effective focal length of the camera optical lens to the entrance pupil diameter.

Image height IH at 1.0 field of view: a height of the field of view corresponding to the active pixel of the sensor (that is, half of the diagonal length of the active pixel area of the sensor).

Field of view FOV at 1.0 field of view: a field of view corresponding to the active pixel of the sensor.

Image height IHm at MIC field of view: a height of the field of view expanding beyond 1.0 field of view for preventing assembly deviation.

Field of view FOVm at MIC field of view: a field of view corresponding to an image height at MIC field of view.

Optionally, the object side surface and/or the image side surface of the lens may also be provided with an inflection point and/or an arrest point, so as to meet high-quality imaging requirements.

Next, the technical solution of the present disclosure will be specifically described with five embodiments. Meanwhile, a comparative embodiment is provided as a reference description, and the technical effects of the present disclosure cannot be achieved when the ranges of the above relational expressions are exceeded.

### First Embodiment

Table 1 and Table 2 show design data of the camera optical lens 10 according to the first embodiment of the present disclosure.

TABLE 1

| | R | d | | nd | | vd | |
|---|---|---|---|---|---|---|---|
| S1 | ∞ | d0 = | −0.992 | | | | |
| R1 | 3.026 | d1 = | 1.190 | nd1 | 1.4959 | v1 | 81.64 |
| R2 | 10.475 | d2 = | 0.381 | | | | |
| R3 | 13.597 | d3 = | 0.285 | nd2 | 1.6797 | v2 | 17.05 |
| R4 | 8.221 | d4 = | 0.196 | | | | |
| R5 | 9.269 | d5 = | 0.290 | nd3 | 1.6797 | v3 | 17.05 |
| R6 | 10.491 | d6 = | 0.398 | | | | |
| R7 | −206.338 | d7 = | 0.713 | nd4 | 1.5444 | v4 | 55.82 |
| R8 | −14.509 | d8 = | 0.338 | | | | |
| R9 | −31.043 | d9 = | 0.330 | nd5 | 1.6700 | v5 | 19.39 |
| R10 | 76.042 | d10 = | 0.376 | | | | |
| R11 | 23.564 | d11 = | 0.599 | nd6 | 1.5661 | v6 | 37.71 |
| R12 | 15.134 | d12 = | 0.292 | | | | |
| R13 | 2.569 | d13 = | 0.586 | nd7 | 1.5346 | v7 | 55.69 |
| R14 | 6.139 | d14 = | 1.210 | | | | |
| R15 | −3.774 | d15 = | 0.546 | nd8 | 1.5346 | v8 | 55.69 |
| R16 | 11.930 | d16 = | 0.350 | | | | |
| R17 | ∞ | d17 = | 0.210 | ndg | 1.5168 | vg | 64.17 |
| R18 | ∞ | d18 = | 0.601 | | | | |

The meaning of each reference sign is as follows:
S1: aperture;
R: central curvature radius at the center of the optical surface;
R1: central curvature radius of the object side surface of the first lens L1;
R2: central curvature radius of the image side surface of the first lens L1;
R3: central curvature radius of the object side surface of the second lens L2;
R4: central curvature radius of the image side surface of the second lens L2;
R5: central curvature radius of the object side surface of the third lens L3;
R6: central curvature radius of the image side surface of the third lens L3;
R7: central curvature radius of the object side surface of the fourth lens L4;
R8: central curvature radius of the image side surface of the fourth lens L4;
R9: central curvature radius of the object side surface of the fifth lens L5;
R10: central curvature radius of the image side surface of the fifth lens L5;
R11: central curvature radius of the object side surface of the sixth lens L6;
R12: central curvature radius of the image side surface of the sixth lens L6;
R13: central curvature radius of the object side surface of the seventh lens L7;
R14: central curvature radius of the image side surface of the seventh lens L7;
R15: central curvature radius of the object side surface of the eighth lens L8;
R16: central curvature radius of the image side surface of the eighth lens L8;
R17: central curvature radius of the object side surface of the grating filter GF;
R18: central curvature radius of the image side surface of the grating filter GF;
d: on-axis thickness of the lens or on-axis distance between the lenses;
d0: on-axis distance from the aperture S1 to the object side surface of the first lens L1;

d1: on-axis thickness of the first lens L1;

d2: on-axis distance from the image side surface of the first lens L1 to the object side surface of the second lens L2;

d3: on-axis thickness of the second lens L2;

d4: on-axis distance from the image side surface of the second lens L2 to the object side surface of the third lens L3;

d5: on-axis thickness of the third lens L3;

d6: on-axis distance from the image side surface of the third lens L3 to the object side surface of the fourth lens L4;

d7: on-axis thickness of the fourth lens L4;

d8: on-axis distance from the image side surface of the fourth lens L4 to the object side surface of the fifth lens L5;

d9: on-axis thickness of the fifth lens L5;

d10: on-axis distance from the image side surface of the fifth lens L5 to the object side surface of the sixth lens L6;

d11: on-axis thickness of the sixth lens L6;

d12: on-axis distance from the image side surface of the sixth lens L6 to the object side surface of the seventh lens L7;

d13: on-axis thickness of the seventh lens L7;

d14: on-axis distance from the image side surface of the seventh lens L7 to the object side surface of the eighth lens L8;

d15: on-axis thickness of the eighth lens L8;

d16: on-axis distance from the image side surface of the eighth lens L8 to the object side surface of the grating filter GF;

d17: on-axis thickness of the grating filter GF;

d18: on-axis distance from the image side surface of the grating filter GF to the image plane Si;

nd: refractive index of d line (the d line is green light with a wavelength of 550 nm);

nd1: refractive index of d line of the first lens L1;

nd2: refractive index of d line of the second lens L2;

nd3: refractive index of d line of the third lens L3;

nd4: refractive index of d line of the fourth lens L4;

nd5: refractive index of d line of the fifth lens L5;

nd6: refractive index of d line of the sixth lens L6;

nd7: refractive index of d line of the seventh lens L7;

nd8: refractive index of d line of the eighth lens L8;

ndg: refractive index of d line of the grating filter GF;

vd: Abbe number;

v1: Abbe number of the first lens L1;

v2: Abbe number of the second lens L2;

v3: Abbe number of the third lens L3;

v4: Abbe number of the fourth lens L4;

v5: Abbe number of the fifth lens L5;

v6: Abbe number of the sixth lens L6;

v7: Abbe number of the seventh lens L7;

v8: Abbe number of the eighth lens L8;

vg: Abbe number of the grating filter GF.

Table 2 shows aspheric data of each lens in the camera optical lens 10 according to the first embodiment of the present disclosure.

TABLE 2

| | Conic Coefficient | Aspheric Coefficient | | | | |
|---|---|---|---|---|---|---|
| | k | A4 | A6 | A8 | A10 | A12 |
| R1 | −6.5736E−01 | 1.8404E−03 | 1.5706E−03 | −1.4612E−03 | 9.4369E−04 | −3.8305E−04 |
| R2 | 2.5776E+00 | −2.8656E−03 | 4.9968E−04 | −6.8350E−04 | 5.8907E−04 | −3.0038E−04 |
| R3 | 1.0796E+01 | −5.4976E−03 | 3.1314E−03 | −5.5698E−03 | 1.1228E−02 | −1.4948E−02 |
| R4 | 1.5433E+01 | −6.8754E−03 | −7.4512E−03 | 2.8925E−02 | −6.6023E−02 | 1.0046E−01 |
| R5 | −5.7262E+01 | −3.0941E−03 | 4.0743E−03 | −3.4462E−02 | 8.5787E−02 | −1.3851E−01 |
| R6 | −4.4092E+01 | −3.4859E−03 | −1.9189E−03 | −5.5301E−03 | 2.1394E−02 | −4.8682E−02 |
| R7 | −8.7368E+01 | −1.3633E−02 | 3.7299E−02 | −1.7264E−01 | 4.6292E−01 | −8.2235E−01 |
| R8 | −3.0199E+01 | −9.1853E−03 | −6.1875E−03 | 1.5005E−03 | 5.0144E−03 | −1.4548E−02 |
| R9 | 9.9888E+01 | −4.3785E−03 | −4.9818E−03 | −2.2581E−02 | 5.0067E−02 | −5.8840E−02 |
| R10 | −9.5351E+01 | −1.6828E−04 | −1.0310E−02 | −3.2533E−03 | 1.2483E−02 | −1.3475E−02 |
| R11 | 2.9266E+01 | −9.9617E−03 | 6.6041E−03 | −4.2503E−03 | 1.5287E−03 | −3.3731E−04 |
| R12 | −6.3476E+01 | −6.4393E−02 | 2.7527E−02 | −7.8978E−03 | 1.6797E−03 | −4.4923E−04 |
| R13 | −7.6627E−01 | −3.3150E−02 | −2.9618E−03 | 3.2859E−03 | −1.5317E−03 | 4.4080E−04 |
| R14 | 3.7073E−01 | 3.9143E−02 | −2.9364E−02 | 1.1036E−02 | −2.9723E−03 | 5.9062E−04 |
| R15 | −1.3864E+01 | −2.4005E−02 | 3.7582E−03 | −6.8834E−04 | 4.1349E−04 | −1.2419E−04 |
| R16 | 3.0088E+00 | −7.1154E−03 | −3.8138E−03 | 1.9193E−03 | −4.8678E−04 | 8.1755E−05 |
| | k | A14 | A16 | A18 | A20 | A22 |
| R1 | −6.5736E−01 | 9.8803E−05 | −1.5776E−05 | 1.4235E−06 | −5.5953E−08 | 0.0000E+00 |
| R2 | 2.5776E+00 | 9.3115E−05 | −1.7236E−05 | 1.7483E−06 | −7.4980E−08 | 0.0000E+00 |
| R3 | 1.0796E+01 | 1.4147E−02 | −9.8513E−03 | 5.0952E−03 | −1.9460E−03 | 5.3903E−04 |
| R4 | 1.5433E+01 | −1.0624E−01 | 8.0062E−02 | −4.3653E−02 | 1.7288E−02 | −4.9328E−03 |
| R5 | −5.7262E+01 | 1.5555E−01 | −1.2470E−01 | 7.2235E−02 | −3.0268E−02 | 9.0770E−03 |
| R6 | −4.4092E+01 | 7.4036E−02 | −7.7557E−02 | 5.7166E−02 | −2.9888E−02 | 1.1023E−02 |
| R7 | −8.7368E+01 | 1.0101E+00 | −8.8119E−01 | 5.5382E−01 | −2.5144E−01 | 8.1690E−02 |
| R8 | −3.0199E+01 | 2.0300E−02 | −1.7833E−02 | 1.0582E−02 | −4.3529E−03 | 1.2454E−03 |
| R9 | 9.9888E+01 | 4.5785E−02 | −2.4911E−02 | 9.6749E−03 | −2.6957E−03 | 5.3465E−04 |
| R10 | −9.5351E+01 | 9.0775E−03 | −4.2053E−03 | 1.3772E−03 | −3.2127E−04 | 5.3050E−05 |
| R11 | 2.9266E+01 | 1.9358E−05 | 2.4228E−05 | −1.2963E−05 | 3.4264E−06 | −5.3480E−07 |
| R12 | −6.3476E+01 | 1.8274E−04 | −5.8731E−05 | 1.1961E−05 | −1.5389E−06 | 1.2564E−07 |
| R13 | −7.6627E−01 | −8.7460E−05 | 1.2536E−05 | −1.3031E−06 | 9.7223E−08 | −5.1211E−09 |
| R14 | 3.7073E−01 | −8.6783E−05 | 9.4418E−06 | −7.6115E−07 | 4.5255E−08 | −1.9560E−09 |
| R15 | −1.3864E+01 | 2.0423E−05 | −2.1269E−06 | 1.5061E−07 | −7.4778E−09 | 2.6172E−10 |
| R16 | 3.0088E+00 | −9.7527E−06 | 8.4504E−07 | −5.3432E−08 | 2.4539E−09 | −8.0713E−11 |

| | k | A24 | A26 | A28 | A30 |
|---|---|---|---|---|---|
| R1 | −6.5736E−01 | 0.0000E+00 | 0.0000E+00 | 0.0000E+00 | 0.0000E+00 |
| R2 | 2.5776E+00 | 0.0000E+00 | 0.0000E+00 | 0.0000E+00 | 0.0000E+00 |
| R3 | 1.0796E+01 | −1.0482E−04 | 1.3517E−05 | −1.0348E−06 | 3.5520E−08 |
| R4 | 1.5433E+01 | 9.8969E−04 | −1.3273E−04 | 1.0702E−05 | −3.9283E−07 |
| R5 | −5.7262E+01 | −1.8971E−03 | 2.6218E−04 | −2.1511E−05 | 7.9273E−07 |
| R6 | −4.4092E+01 | −2.8038E−03 | 4.6793E−04 | −4.6113E−05 | 2.0336E−06 |
| R7 | −8.7368E+01 | −1.8515E−02 | 2.7798E−03 | −2.4841E−04 | 1.0001E−05 |
| R8 | −3.0199E+01 | −2.4347E−04 | 3.1041E−05 | −2.3270E−06 | 7.7830E−08 |
| R9 | 9.9888E+01 | −7.3677E−05 | 6.7054E−06 | −3.6238E−07 | 8.8052E−09 |
| R10 | −9.5351E+01 | −6.0601E−06 | 4.5561E−07 | −2.0282E−08 | 4.0498E−10 |
| R11 | 2.9266E+01 | 4.9730E−08 | −2.5496E−09 | 5.5492E−11 | 0.0000E+00 |
| R12 | −6.3476E+01 | −6.3314E−09 | 1.8003E−10 | −2.2130E−12 | 0.0000E+00 |
| R13 | −7.6627E−01 | 1.8528E−10 | −4.3750E−12 | 6.0683E−14 | −3.7494E−16 |
| R14 | 3.7073E−01 | 5.9659E−11 | −1.2147E−12 | 1.4787E−14 | −8.1252E−17 |
| R15 | −1.3864E+01 | −6.3443E−12 | 1.0157E−13 | −9.6699E−16 | 4.1488E−18 |
| R16 | 3.0088E+00 | 1.8491E−12 | −2.7986E−14 | 2.5133E−16 | −1.0136E−18 |

For convenience, the aspheric of each lens surface uses the aspheric shown in the following formula (1). However, the present disclosure is not limited to the aspheric polynomial form represented by formula (1).

$$z = ( {cr}^{2} ) / \{ 1 + {[ 1 - ( k + 1 ) ( {c}^{2} {r}^{2} ) ]}^{1 / 2} \} + {A 4 r}^{4} + {A 6 r}^{6} + {A 8 r}^{8} + {A 10 r}^{10} + {A 12 r}^{12} + {A 14 r}^{14} + {A 16 r}^{16} {A 18 r}^{18} + {A 20 r}^{20} + {A 22 r}^{22} + {A 24 r}^{24} + {A 26 r}^{26} + {A 28 r}^{28} + {A 30 r}^{30} , \qquad ( 1 )$$

where k represents a conic coefficient, A4, A6, A8, A10, A12, A14, A16, A18, A20, A22, A24, A26, A28 and A30 represent aspheric coefficients, c represents a curvature at the center of the optical plane, r represents a vertical distance between a point on the aspheric curve and the optical axis, and z represents a depth of the aspheric (a vertical distance between a point on the aspheric at a distance r from the optical axis and a tangent plane tangent to a vertex on the aspheric optical axis).

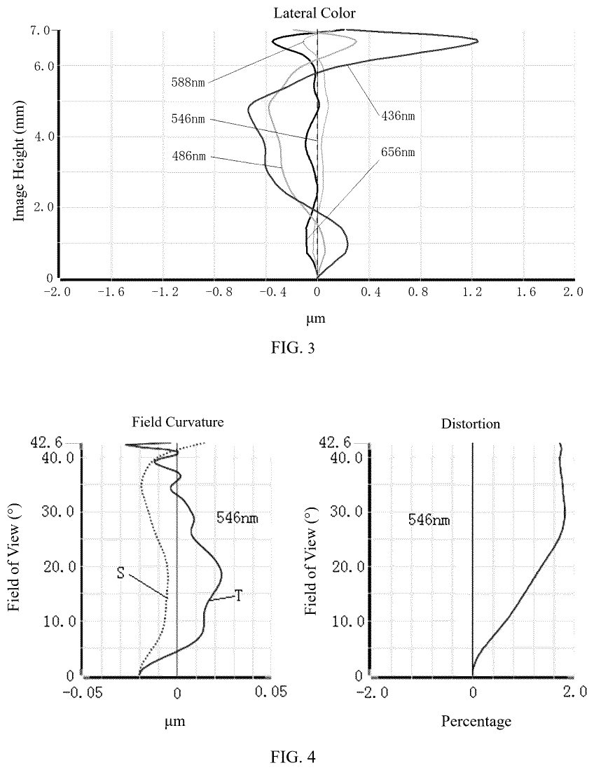

FIG. 2 and FIG. 3 respectively show longitudinal aberration and lateral color of the light at wavelengths of 656 nm, 588 nm, 546 nm, 486 nm, and 436 nm after passing through the camera optical lens 10 according to the first embodiment. FIG. 4 shows a schematic diagram of field curvature and distortion of the light at a wavelength of 546 nm after passing through the camera optical lens 10 according to the first embodiment. In FIG. 4, the field curvature S is a field curvature in a sagittal direction, and T is a field curvature in a meridian direction.

In this embodiment, the entrance pupil diameter ENPD of the camera optical lens 10 is 4.618 mm, the image height IH at the 1.0 field of view is 7.000 mm, the field of view FOV at the 1.0 field of view is 85.27°, the image height IHm at the MIC field of view is 7.3500 mm, and the field of view FOVm at the MIC field of view is 88.66°. The camera optical lens 10 meets the design requirements of large aperture, wide-angle and ultra-thin, effectively correcting both the on-axis and off-axis chromatic aberrations thereof, and has excellent optical characteristics.

### Second Embodiment

The meaning of the reference signs of the second embodiment is the same as that of the first embodiment.

FIG. 5 shows a camera optical lens 20 according to the second embodiment of the present disclosure.

Table 3 and Table 4 show design data of the camera optical lens 20 according to the second embodiment of the present disclosure.

TABLE 3

| | R | d | | nd | | vd | |
|---|---|---|---|---|---|---|---|
| S1 | ∞ | d0 = | −1.028 | | | | |
| R1 | 3.001 | d1 = | 1.195 | nd1 | 1.4959 | v1 | 81.64 |
| R2 | 10.145 | d2 = | 0.383 | | | | |
| R3 | 13.640 | d3 = | 0.277 | nd2 | 1.6797 | v2 | 17.05 |
| R4 | 8.189 | d4 = | 0.206 | | | | |
| R5 | 9.036 | d5 = | 0.335 | nd3 | 1.6797 | v3 | 17.05 |
| R6 | 10.990 | d6 = | 0.435 | | | | |
| R7 | −67.848 | d7 = | 0.679 | nd4 | 1.5444 | v4 | 55.82 |
| R8 | −14.750 | d8 = | 0.328 | | | | |
| R9 | −25.910 | d9 = | 0.320 | nd5 | 1.6700 | v5 | 19.39 |
| R10 | 144.072 | d10 = | 0.371 | | | | |
| R11 | 23.094 | d11 = | 0.588 | nd6 | 1.5661 | v6 | 37.71 |
| R12 | 14.684 | d12 = | 0.292 | | | | |
| R13 | 2.576 | d13 = | 0.561 | nd7 | 1.5346 | v7 | 55.69 |
| R14 | 6.102 | d14 = | 1.215 | | | | |
| R15 | −3.822 | d15 = | 0.601 | nd8 | 1.5346 | v8 | 55.69 |
| R16 | 11.850 | d16 = | 0.347 | | | | |
| R17 | ∞ | d17 = | 0.210 | ndg | 1.5168 | vg | 64.17 |
| R18 | ∞ | d18 = | 0.595 | | | | |

Table 4 shows aspheric data of each lens in the camera optical lens 20 according to the second embodiment of the present disclosure.

TABLE 4

| | Conic Coefficient | Aspheric Coefficient | | | | |
|---|---|---|---|---|---|---|
| | k | A4 | A6 | A8 | A10 | A12 |
| R1 | −6.4055E−01 | 1.8981E−03 | 1.5758E−03 | −1.4595E−03 | 9.4370E−04 | −3.8310E−04 |
| R2 | 2.6602E+00 | −2.8890E−03 | 5.0329E−04 | −6.8576E−04 | 5.8776E−04 | −3.0038E−04 |
| R3 | 1.1370E+01 | −5.2753E−03 | 3.1691E−03 | −5.5579E−03 | 1.1232E−02 | −1.4949E−02 |
| R4 | 1.5396E+01 | −7.1234E−03 | −7.3942E−03 | 2.8921E−02 | −6.6022E−02 | 1.0046E−01 |
| R5 | −5.4285E+01 | −3.0109E−03 | 4.0679E−03 | −3.4468E−02 | 8.5784E−02 | −1.3851E−01 |
| R6 | −4.1668E+01 | −3.2700E−03 | −1.8406E−03 | −5.5145E−03 | 2.1394E−02 | −4.8681E−02 |
| R7 | −5.9670E+01 | −1.3283E−02 | 3.7222E−02 | −1.7264E−01 | 4.6292E−01 | −8.2235E−01 |
| R8 | −3.4446E+01 | −9.4254E−03 | −6.2572E−03 | 1.4925E−03 | 5.0105E−03 | −1.4548E−02 |
| R9 | 1.0030E+02 | −4.3767E−03 | −5.0257E−03 | −2.2579E−02 | 5.0067E−02 | −5.8841E−02 |
| R10 | 6.6852E+00 | −5.5542E−05 | −1.0332E−02 | −3.2533E−03 | 1.2483E−02 | −1.3475E−02 |
| R11 | 2.2161E+01 | −9.9875E−03 | 6.6016E−03 | −4.2509E−03 | 1.5300E−03 | −3.3730E−04 |
| R12 | −7.7112E+01 | −6.4574E−02 | 2.7525E−02 | −7.8976E−03 | 1.6796E−03 | −4.4923E−04 |
| R13 | −7.6780E−01 | −3.3147E−02 | −2.9624E−03 | 3.2857E−03 | −1.5317E−03 | 4.4080E−04 |
| R14 | 3.6852E−01 | 3.9043E−02 | −2.9365E−02 | 1.1036E−02 | −2.9723E−03 | 5.9062E−04 |
| R15 | −1.3666E+01 | −2.3989E−02 | 3.7569E−03 | −6.8839E−04 | 4.1349E−04 | −1.2419E−04 |
| R16 | 2.9708E+00 | −7.2774E−03 | −3.8100E−03 | 1.9192E−03 | −4.8678E−04 | 8.1755E−05 |
| | k | A14 | A16 | A18 | A20 | A22 |
| R1 | −6.4055E−01 | 9.8771E−05 | −1.5776E−05 | 1.4233E−06 | −5.5964E−08 | 2.3577E−11 |
| R2 | 2.6602E+00 | 9.3004E−05 | −1.7230E−05 | 1.7557E−06 | −7.5534E−08 | 1.6360E−12 |
| R3 | 1.1370E+01 | 1.4147E−02 | −9.8513E−03 | 5.0952E−03 | −1.9460E−03 | 5.3903E−04 |
| R4 | 1.5396E+01 | −1.0624E−01 | 8.0062E−02 | −4.3653E−02 | 1.7288E−02 | −4.9328E−03 |
| R5 | −5.4285E+01 | 1.5555E−01 | −1.2470E−01 | 7.2235E−02 | −3.0268E−02 | 9.0770E−03 |
| R6 | −4.1668E+01 | 7.4034E−02 | −7.7557E−02 | 5.7166E−02 | −2.9888E−02 | 1.1023E−02 |
| R7 | −5.9670E+01 | 1.0101E+00 | −8.8119E−01 | 5.5382E−01 | −2.5144E−01 | 8.1690E−02 |
| R8 | −3.4446E+01 | 2.0300E−02 | −1.7833E−02 | 1.0582E−02 | −4.3529E−03 | 1.2454E−03 |
| R9 | 1.0030E+02 | 4.5785E−02 | −2.4911E−02 | 9.6749E−03 | −2.6957E−03 | 5.3465E−04 |
| R10 | 6.6852E+00 | 9.0775E−03 | −4.2053E−03 | 1.3772E−03 | −3.2127E−04 | 5.3050E−05 |
| R11 | 2.2161E+01 | 1.9358E−05 | 2.4227E−05 | −1.2963E−05 | 3.4264E−06 | −5.3479E−07 |
| R12 | −7.7112E+01 | 1.8274E−04 | −5.8731E−05 | 1.1961E−05 | −1.5389E−06 | 1.2563E−07 |
| R13 | −7.6780E−01 | −8.7460E−05 | 1.2536E−05 | −1.3031E−06 | 9.7223E−08 | −5.1211E−09 |
| R14 | 3.6852E−01 | −8.6783E−05 | 9.4418E−06 | −7.6115E−07 | 4.5255E−08 | −1.9560E−09 |
| R15 | −1.3666E+01 | 2.0423E−05 | −2.1269E−06 | 1.5061E−07 | −7.4778E−09 | 2.6172E−10 |
| R16 | 2.9708E+00 | −9.7527E−06 | 8.4504E−07 | −5.3432E−08 | 2.4539E−09 | −8.0713E−11 |

| | k | A24 | A26 | A28 | A30 |
|---|---|---|---|---|---|
| R1 | −6.4055E−01 | −7.1552E−12 | −6.9780E−13 | 1.2693E−14 | 1.4341E−14 |
| R2 | 2.6602E+00 | −1.0310E−11 | −1.3204E−12 | −4.0171E−13 | 5.9318E−14 |
| R3 | 1.1370E+01 | −1.0482E−04 | 1.3517E−05 | −1.0348E−06 | 3.5524E−08 |
| R4 | 1.5396E+01 | 9.8969E−04 | −1.3273E−04 | 1.0702E−05 | −3.9286E−07 |
| R5 | −5.4285E+01 | −1.8971E−03 | 2.6218E−04 | −2.1511E−05 | 7.9272E−07 |
| R6 | −4.1668E+01 | −2.8038E−03 | 4.6793E−04 | −4.6113E−05 | 2.0335E−06 |
| R7 | −5.9670E+01 | −1.8515E−02 | 2.7798E−03 | −2.4841E−04 | 1.0001E−05 |
| R8 | −3.4446E+01 | −2.4347E−04 | 3.1041E−05 | −2.3270E−06 | 7.7831E−08 |
| R9 | 1.0030E+02 | −7.3677E−05 | 6.7054E−06 | −3.6238E−07 | 8.8051E−09 |
| R10 | 6.6852E+00 | −6.0601E−06 | 4.5561E−07 | −2.0282E−08 | 4.0498E−10 |
| R11 | 2.2161E+01 | 4.9730E−08 | −2.5496E−09 | 5.5490E−11 | −1.4628E−16 |
| R12 | −7.7112E+01 | −6.3314E−09 | 1.8003E−10 | −2.2130E−12 | −8.8251E−19 |
| R13 | −7.6780E−01 | 1.8528E−10 | −4.3750E−12 | 6.0683E−14 | −3.7494E−16 |
| R14 | 3.6852E−01 | 5.9659E−11 | −1.2147E−12 | 1.4787E−14 | −8.1252E−17 |
| R15 | −1.3666E+01 | −6.3443E−12 | 1.0157E−13 | −9.6699E−16 | 4.1488E−18 |
| R16 | 2.9708E+00 | 1.8491E−12 | −2.7986E−14 | 2.5133E−16 | −1.0136E−18 |

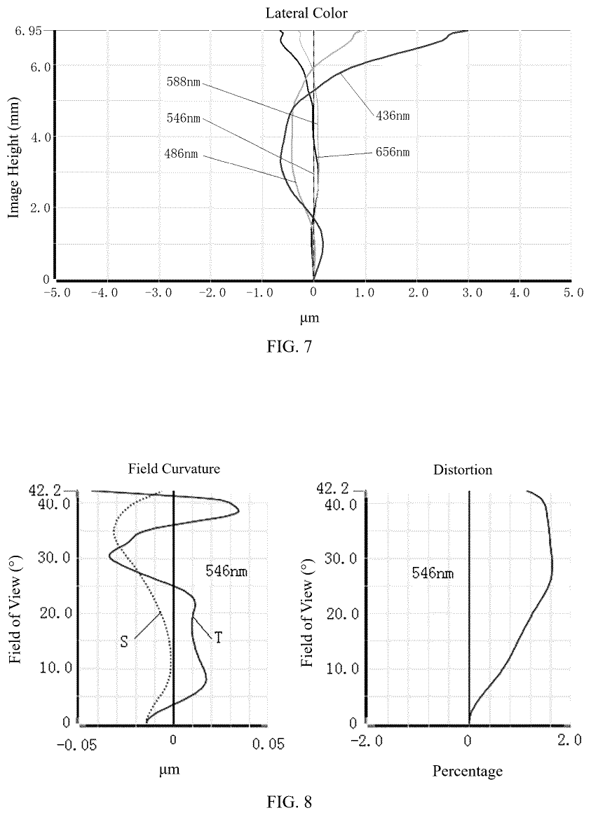

FIG. 6 and FIG. 7 respectively show longitudinal aberration and lateral color of the light at wavelengths of 656 nm, 588 nm, 546 nm, 486 nm, and 436 nm after passing through the camera optical lens 20 according to the second embodiment. FIG. 8 shows a schematic diagram of the field curvature and the distortion of the light at a wavelength of 546 nm after passing through the camera optical lens 20 according to the second embodiment. In FIG. 8, the field curvature S is a field curvature in a sagittal direction, and T is a field curvature in a meridian direction.

In this embodiment, the entrance pupil diameter ENPD of the camera optical lens 20 is 4.693 mm, the image height IH at the 1.0 field of view is 6.947 mm, the field of view FOV at the 1.0 field of view is 84.33°, the image height IHm at the MIC field of view is 7.089 mm, and the field of view FOVm at the MIC field of view is 85.71°. The camera optical lens 20 meets the design requirements of large aperture, wide-angle and ultra-thin, effectively correcting both the on-axis and off-axis chromatic aberrations thereof, and has excellent optical characteristics.

### Third Embodiment

The meaning of the reference signs of the third embodiment is the same as that of the first embodiment.

FIG. 9 shows a camera optical lens 30 according to the third embodiment of the present disclosure.

Table 5 and Table 6 show design data of the camera optical lens 30 according to the third embodiment of the present disclosure.

TABLE 5

| | R | d | | nd | | vd | |
|---|---|---|---|---|---|---|---|
| S1 | ∞ | d0 = | −0.962 | | | | |
| R1 | 3.020 | d1 = | 1.174 | nd1 | 1.5164 | v1 | 60.09 |
| R2 | 10.323 | d2 = | 0.365 | | | | |
| R3 | 13.887 | d3 = | 0.294 | nd2 | 1.6797 | v2 | 17.05 |
| R4 | 8.153 | d4 = | 0.205 | | | | |
| R5 | 10.007 | d5 = | 0.231 | nd3 | 1.6797 | v3 | 17.05 |
| R6 | 10.668 | d6 = | 0.402 | | | | |
| R7 | −100.397 | d7 = | 0.717 | nd4 | 1.5444 | v4 | 55.82 |
| R8 | −12.343 | d8 = | 0.339 | | | | |
| R9 | −29.267 | d9 = | 0.412 | nd5 | 1.6700 | v5 | 19.39 |
| R10 | 86.089 | d10 = | 0.394 | | | | |
| R11 | 24.840 | d11 = | 0.603 | nd6 | 1.5661 | v6 | 37.71 |
| R12 | 15.642 | d12 = | 0.289 | | | | |
| R13 | 2.578 | d13 = | 0.591 | nd7 | 1.5346 | v7 | 55.69 |
| R14 | 6.183 | d14 = | 1.199 | | | | |
| R15 | −3.791 | d15 = | 0.535 | nd8 | 1.5346 | v8 | 55.69 |
| R16 | 11.912 | d16 = | 0.283 | | | | |
| R15 | ∞ | d17 = | 0.210 | ndg | 1.5168 | vg | 64.17 |
| R16 | ∞ | d18 = | 0.566 | | | | |

Table 6 shows aspheric data of each lens in the camera optical lens 30 according to the third embodiment of the present disclosure.

TABLE 6

| | Conic Coefficient | Aspheric Coefficient | | | | |
|---|---|---|---|---|---|---|
| | k | A4 | A6 | A8 | A10 | A12 |
| R1 | −6.4917E−01 | 2.0239E−03 | 1.6072E−03 | −1.4574E−03 | 9.4411E−04 | −3.8306E−04 |
| R2 | 2.0893E+00 | −3.0146E−03 | 4.4044E−04 | −6.8789E−04 | 5.8862E−04 | −3.0058E−04 |
| R3 | 8.1003E+00 | −6.2565E−03 | 3.0728E−03 | −5.5685E−03 | 1.1228E−02 | −1.4948E−02 |
| R4 | 1.5499E+01 | −6.3381E−03 | −7.4429E−03 | 2.8923E−02 | −6.6026E−02 | 1.0046E−01 |
| R5 | −5.9535E+01 | −3.0081E−03 | 4.1532E−03 | −3.4457E−02 | 8.5789E−02 | −1.3851E−01 |
| R6 | −4.1623E+01 | −2.8481E−03 | −1.7509E−03 | −5.5092E−03 | 2.1402E−02 | −4.8680E−02 |
| R7 | −9.8413E+02 | −1.2463E−02 | 3.7397E−02 | −1.7262E−01 | 4.6292E−01 | −8.2235E−01 |
| R8 | −2.5326E+01 | −9.2771E−03 | −6.1791E−03 | 1.5115E−03 | 5.0190E−03 | −1.4548E−02 |
| R9 | 8.9257E+01 | −4.2938E−03 | −4.9643E−03 | −2.2572E−02 | 5.0069E−02 | −5.8840E−02 |
| R10 | −1.8405E+02 | −3.8381E−04 | −1.0375E−02 | −3.2601E−03 | 1.2482E−02 | −1.3475E−02 |
| R11 | 2.1848E+01 | −1.0068E−02 | 6.5740E−03 | −4.2502E−03 | 1.5285E−03 | −3.3735E−04 |
| R12 | −6.3355E+01 | −6.4306E−02 | 2.7528E−02 | −7.8976E−03 | 1.6797E−03 | −4.4923E−04 |
| R13 | −7.6621E−01 | −3.3156E−02 | −2.9619E−03 | 3.2859E−03 | −1.5317E−03 | 4.4080E−04 |
| R14 | 3.6939E−01 | 3.9127E−02 | −2.9363E−02 | 1.1036E−02 | −2.9723E−03 | 5.9062E−04 |
| R15 | −1.3563E+01 | −2.4010E−02 | 3.7582E−03 | −6.8837E−04 | 4.1349E−04 | −1.2419E−04 |
| R16 | 2.9855E+00 | −7.2678E−03 | −3.8153E−03 | 1.9193E−03 | −4.8678E−04 | 8.1755E−05 |
| | k | A14 | A16 | A18 | A20 | A22 |
| R1 | −6.4917E−01 | 9.8796E−05 | −1.5780E−05 | 1.4232E−06 | −5.6060E−08 | −1.5956E−11 |
| R2 | 2.0893E+00 | 9.3076E−05 | −1.7240E−05 | 1.7460E−06 | −7.5385E−08 | −7.1639E−11 |
| R3 | 8.1003E+00 | 1.4147E−02 | −9.8513E−03 | 5.0952E−03 | −1.9460E−03 | 5.3903E−04 |
| R4 | 1.5499E+01 | −1.0624E−01 | 8.0062E−02 | −4.3653E−02 | 1.7288E−02 | −4.9328E−03 |
| R5 | −5.9535E+01 | 1.5555E−01 | −1.2470E−01 | 7.2235E−02 | −3.0268E−02 | 9.0770E−03 |
| R6 | −4.1623E+01 | 7.4036E−02 | −7.7557E−02 | 5.7166E−02 | −2.9888E−02 | 1.1023E−02 |
| R7 | −9.8413E+02 | 1.0100E+00 | −8.8119E−01 | 5.5382E−01 | −2.5144E−01 | 8.1690E−02 |
| R8 | −2.5326E+01 | 2.0300E−02 | −1.7833E−02 | 1.0582E−02 | −4.3529E−03 | 1.2454E−03 |
| R9 | 8.9257E+01 | 4.5785E−02 | −2.4911E−02 | 9.6749E−03 | −2.6957E−03 | 5.3465E−04 |
| R10 | −1.8405E+02 | 9.0775E−03 | −4.2053E−03 | 1.3772E−03 | −3.2127E−04 | 5.3050E−05 |
| R11 | 2.1848E+01 | 1.9347E−05 | 2.4227E−05 | −1.2963E−05 | 3.4264E−06 | −5.3480E−07 |
| R12 | −6.3355E+01 | 1.8274E−04 | −5.8731E−05 | 1.1961E−05 | −1.5389E−06 | 1.2564E−07 |
| R13 | −7.6621E−01 | −8.7460E−05 | 1.2536E−05 | −1.3031E−06 | 9.7223E−08 | −5.1211E−09 |
| R14 | 3.6939E−01 | −8.6783E−05 | 9.4418E−06 | −7.6115E−07 | 4.5255E−08 | −1.9560E−09 |
| R15 | −1.3563E+01 | 2.0423E−05 | −2.1269E−06 | 1.5061E−07 | −7.4778E−09 | 2.6172E−10 |
| R16 | 2.9855E+00 | −9.7527E−06 | 8.4504E−07 | −5.3432E−08 | 2.4539E−09 | −8.0713E−11 |

| | k | A24 | A26 | A28 | A30 |
|---|---|---|---|---|---|
| R1 | −6.4917E−01 | −6.1900E−12 | −4.8163E−13 | −1.2045E−13 | −4.6769E−14 |
| R2 | 2.0893E+00 | −1.2735E−11 | −8.4958E−13 | −3.0976E−13 | 2.3775E−13 |
| R3 | 8.1003E+00 | −1.0482E−04 | 1.3517E−05 | −1.0348E−06 | 3.5521E−08 |
| R4 | 1.5499E+01 | 9.8969E−04 | −1.3273E−04 | 1.0702E−05 | −3.9284E−07 |
| R5 | −5.9535E+01 | −1.8971E−03 | 2.6218E−04 | −2.1511E−05 | 7.9274E−07 |
| R6 | −4.1623E+01 | −2.8038E−03 | 4.6793E−04 | −4.6113E−05 | 2.0335E−06 |
| R7 | −9.8413E+02 | −1.8515E−02 | 2.7798E−03 | −2.4841E−04 | 1.0001E−05 |
| R8 | −2.5326E+01 | −2.4347E−04 | 3.1041E−05 | −2.3270E−06 | 7.7830E−08 |
| R9 | 8.9257E+01 | −7.3677E−05 | 6.7054E−06 | −3.6238E−07 | 8.8052E−09 |
| R10 | −1.8405E+02 | −6.0601E−06 | 4.5561E−07 | −2.0282E−08 | 4.0498E−10 |
| R11 | 2.1848E+01 | 4.9730E−08 | −2.5496E−09 | 5.5494E−11 | 1.4784E−16 |
| R12 | −6.3355E+01 | −6.3314E−09 | 1.8003E−10 | −2.2130E−12 | 1.1997E−19 |
| R13 | −7.6621E−01 | 1.8528E−10 | −4.3750E−12 | 6.0683E−14 | −3.7494E−16 |
| R14 | 3.6939E−01 | 5.9659E−11 | −1.2147E−12 | 1.4787E−14 | −8.1252E−17 |
| R15 | −1.3563E+01 | −6.3443E−12 | 1.0157E−13 | −9.6699E−16 | 4.1488E−18 |
| R16 | 2.9855E+00 | 1.8491E−12 | −2.7986E−14 | 2.5133E−16 | −1.0136E−18 |

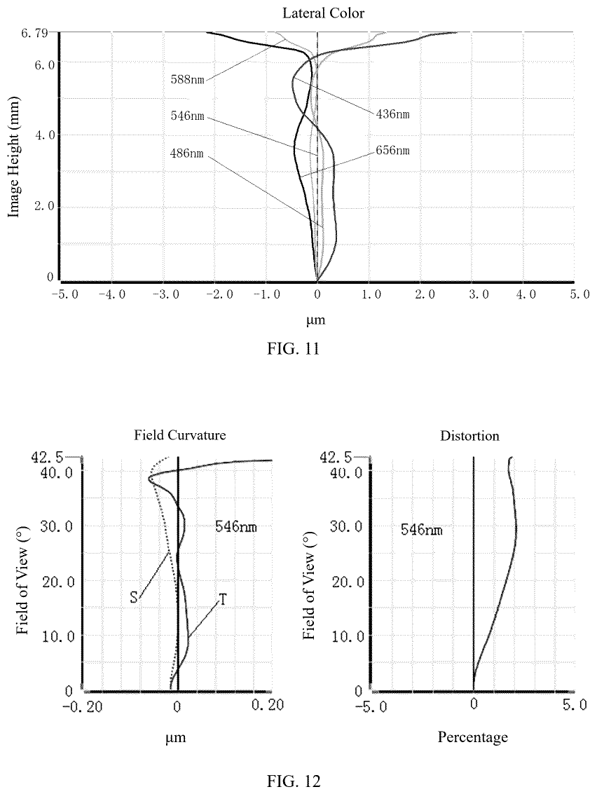

FIG. 10 and FIG. 11 respectively show longitudinal aberration and lateral color of the light at wavelengths of 656 nm, 588 nm, 546 nm, 486 nm, and 436 nm after passing through the camera optical lens 30 according to the third embodiment. FIG. 12 shows a schematic diagram of the field curvature and the distortion of the light at a wavelength of 546 nm after passing through the camera optical lens 30 according to the third embodiment. In FIG. 12, the field curvature S is a field curvature in a sagittal direction, and T is a field curvature in a meridional direction.

In this embodiment, the entrance pupil diameter ENPD of the camera optical lens 30 is 4.517 mm, the image height IH at the 1.0 field of view is 6.792 mm, the field of view FOV at the 1.0 field of view is 85.00°, the image height IHm at the MIC field of view is 7.074 mm, and the field of view FOVm at the MIC field of view is 86.22°. The camera optical lens 30 meets the design requirements of large aperture, wide-angle and ultra-thin, effectively correcting both the on-axis and off-axis chromatic aberrations thereof, and has excellent optical characteristics.

### Fourth Embodiment

The meaning of the reference signs of the fourth embodiment is the same as that of the first embodiment.

FIG. 13 shows a camera optical lens 40 according to the fourth embodiment of the present disclosure.

Table 7 and Table 8 show design data of the camera optical lens 40 according to the fourth embodiment of the present disclosure.

TABLE 7

| | R | d | | nd | | vd | |
|---|---|---|---|---|---|---|---|
| S1 | ∞ | d0 = | −0.982 | | | | |
| R1 | 3.040 | d1 = | 1.097 | nd1 | 1.4959 | v1 | 81.64 |
| R2 | 10.349 | d2 = | 0.348 | | | | |
| R3 | 12.558 | d3 = | 0.273 | nd2 | 1.6797 | v2 | 17.05 |
| R4 | 8.366 | d4 = | 0.187 | | | | |
| R5 | 9.724 | d5 = | 0.259 | nd3 | 1.6797 | v3 | 17.05 |
| R6 | 10.947 | d6 = | 0.383 | | | | |
| R7 | −216.570 | d7 = | 0.635 | nd4 | 1.5444 | v4 | 55.82 |
| R8 | −13.903 | d8 = | 0.324 | | | | |
| R9 | −30.504 | d9 = | 0.278 | nd5 | 1.6700 | v5 | 19.39 |
| R10 | 89.462 | d10 = | 0.353 | | | | |
| R11 | 22.690 | d11 = | 0.572 | nd6 | 1.5661 | v6 | 37.71 |
| R12 | 16.833 | d12 = | 0.273 | | | | |
| R13 | 2.545 | d13 = | 0.566 | nd7 | 1.5346 | v7 | 55.69 |
| R14 | 6.187 | d14 = | 1.173 | | | | |
| R15 | −4.143 | d15 = | 0.477 | nd8 | 1.5346 | v8 | 55.69 |
| R16 | 12.023 | d16 = | 0.397 | | | | |
| R17 | ∞ | d17 = | 0.210 | ndg | 1.5168 | vg | 64.17 |
| R18 | ∞ | d18 = | 0.658 | | | | |

Table 8 shows aspheric data of each lens in the camera optical lens 40 according to the fourth embodiment of the present disclosure.

TABLE 8

| | Conic Coefficient | Aspheric Coefficient | | | | |
|---|---|---|---|---|---|---|
| | k | A4 | A6 | A8 | A10 | A12 |
| R1 | −6.6856E−01 | 1.7137E−03 | 1.5541E−03 | −1.4640E−03 | 9.4341E−04 | −3.8312E−04 |
| R2 | 2.6213E+00 | −2.7889E−03 | 4.9532E−04 | −6.8290E−04 | 5.8898E−04 | −3.0038E−04 |
| R3 | 1.0713E+01 | −5.5546E−03 | 3.1109E−03 | −5.5772E−03 | 1.1226E−02 | −1.4949E−02 |
| R4 | 1.5442E+01 | −6.7748E−03 | −7.4535E−03 | 2.8927E−02 | −6.6027E−02 | 1.0046E−01 |
| R5 | −5.8780E+01 | −3.2316E−03 | 4.0719E−03 | −3.4459E−02 | 8.5782E−02 | −1.3851E−01 |
| R6 | −4.1036E+01 | −3.4182E−03 | −1.9296E−03 | −5.5392E−03 | 2.1391E−02 | −4.8682E−02 |
| R7 | 8.7802E+02 | −1.3525E−02 | 3.7348E−02 | −1.7262E−01 | 4.6292E−01 | −8.2235E−01 |
| R8 | −2.6457E+01 | −9.3319E−03 | −6.1926E−03 | 1.5029E−03 | 5.0162E−03 | −1.4548E−02 |
| R9 | 9.7389E+01 | −4.2061E−03 | −4.9894E−03 | −2.2585E−02 | 5.0066E−02 | −5.8840E−02 |
| R10 | −1.0023E+02 | −2.9548E−05 | −1.0286E−02 | −3.2499E−03 | 1.2483E−02 | −1.3475E−02 |
| R11 | 2.9495E+01 | −1.0109E−02 | 6.6248E−03 | −4.2498E−03 | 1.5286E−03 | −3.3733E−04 |
| R12 | −6.2612E+01 | −6.4279E−02 | 2.7531E−02 | −7.8967E−03 | 1.6797E−03 | −4.4923E−04 |
| R13 | −7.6631E−01 | −3.3152E−02 | −2.9618E−03 | 3.2859E−03 | −1.5317E−03 | 4.4080E−04 |
| R14 | 3.7967E−01 | 3.9097E−02 | −2.9363E−02 | 1.1036E−02 | −2.9723E−03 | 5.9062E−04 |
| R15 | −1.5449E+01 | −2.4023E−02 | 3.7580E−03 | −6.8834E−04 | 4.1349E−04 | −1.2419E−04 |
| R16 | 3.0052E+00 | −7.2232E−03 | −3.8145E−03 | 1.9193E−03 | −4.8678E−04 | 8.1755E−05 |
| | k | A14 | A16 | A18 | A20 | A22 |
| R1 | −6.6856E−01 | 9.8793E−05 | −1.5777E−05 | 1.4233E−06 | −5.6000E−08 | −6.1558E−12 |
| R2 | 2.6213E+00 | 9.3108E−05 | −1.7237E−05 | 1.7481E−06 | −7.5073E−08 | −1.3806E−11 |
| R3 | 1.0713E+01 | 1.4147E−02 | −9.8514E−03 | 5.0952E−03 | −1.9460E−03 | 5.3903E−04 |
| R4 | 1.5442E+01 | −1.0624E−01 | 8.0062E−02 | −4.3653E−02 | 1.7288E−02 | −4.9328E−03 |
| R5 | −5.8780E+01 | 1.5555E−01 | −1.2470E−01 | 7.2235E−02 | −3.0268E−02 | 9.0770E−03 |
| R6 | −4.1036E+01 | 7.4036E−02 | −7.7557E−02 | 5.7166E−02 | −2.9888E−02 | 1.1023E−02 |
| R7 | 8.7802E+02 | 1.0101E+00 | −8.8119E−01 | 5.5382E−01 | −2.5144E−01 | 8.1690E−02 |
| R8 | −2.6457E+01 | 2.0300E−02 | −1.7833E−02 | 1.0582E−02 | −4.3529E−03 | 1.2454E−03 |
| R9 | 9.7389E+01 | 4.5785E−02 | −2.4911E−02 | 9.6749E−03 | −2.6957E−03 | 5.3465E−04 |
| R10 | −1.0023E+02 | 9.0775E−03 | −4.2053E−03 | 1.3772E−03 | −3.2127E−04 | 5.3050E−05 |
| R11 | 2.9495E+01 | 1.9355E−05 | 2.4228E−05 | −1.2963E−05 | 3.4264E−06 | −5.3480E−07 |
| R12 | −6.2612E+01 | 1.8274E−04 | −5.8731E−05 | 1.1961E−05 | −1.5389E−06 | 1.2564E−07 |
| R13 | −7.6631E−01 | −8.7460E−05 | 1.2536E−05 | −1.3031E−06 | 9.7223E−08 | −5.1211E−09 |
| R14 | 3.7967E−01 | −8.6783E−05 | 9.4418E−06 | −7.6115E−07 | 4.5255E−08 | −1.9560E−09 |
| R15 | −1.5449E+01 | 2.0423E−05 | −2.1269E−06 | 1.5061E−07 | −7.4778E−09 | 2.6172E−10 |
| R16 | 3.0052E+00 | −9.7527E−06 | 8.4504E−07 | −5.3432E−08 | 2.4539E−09 | −8.0713E−11 |

| | k | A24 | A26 | A28 | A30 |
|---|---|---|---|---|---|
| R1 | −6.6856E−01 | 9.7982E−14 | −3.5247E−13 | −9.0276E−15 | −6.1553E−15 |
| R2 | 2.6213E+00 | −8.1862E−12 | −1.1604E−12 | −1.8445E−13 | −4.0189E−14 |
| R3 | 1.0713E+01 | −1.0482E−04 | 1.3516E−05 | −1.0348E−06 | 3.5519E−08 |
| R4 | 1.5442E+01 | 9.8969E−04 | −1.3273E−04 | 1.0702E−05 | −3.9283E−07 |
| R5 | −5.8780E+01 | −1.8971E−03 | 2.6218E−04 | −2.1511E−05 | 7.9273E−07 |
| R6 | −4.1036E+01 | −2.8038E−03 | 4.6793E−04 | −4.6113E−05 | 2.0335E−06 |
| R7 | 8.7802E+02 | −1.8515E−02 | 2.7798E−03 | −2.4841E−04 | 1.0001E−05 |
| R8 | −2.6457E+01 | −2.4347E−04 | 3.1041E−05 | −2.3270E−06 | 7.7830E−08 |
| R9 | 9.7389E+01 | −7.3677E−05 | 6.7054E−06 | −3.6238E−07 | 8.8051E−09 |
| R10 | −1.0023E+02 | −6.0601E−06 | 4.5561E−07 | −2.0282E−08 | 4.0498E−10 |
| R11 | 2.9495E+01 | 4.9730E−08 | −2.5496E−09 | 5.5491E−11 | 8.0314E−17 |
| R12 | −6.2612E+01 | −6.3314E−09 | 1.8003E−10 | −2.2130E−12 | −5.1086E−19 |
| R13 | −7.6631E−01 | 1.8528E−10 | −4.3750E−12 | 6.0683E−14 | −3.7494E−16 |
| R14 | 3.7967E−01 | 5.9659E−11 | −1.2147E−12 | 1.4787E−14 | −8.1252E−17 |
| R15 | −1.5449E+01 | −6.3443E−12 | 1.0157E−13 | −9.6699E−16 | 4.1488E−18 |
| R16 | 3.0052E+00 | 1.8491E−12 | −2.7986E−14 | 2.5133E−16 | −1.0136E−18 |

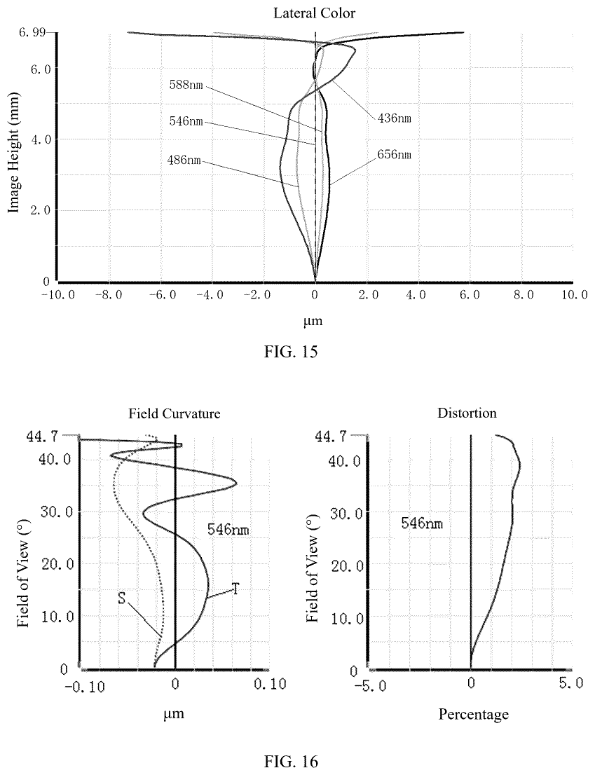

FIG. 14 and FIG. 15 respectively show longitudinal aberration and lateral color of the light at wavelengths of 656 nm, 588 nm, 546 nm, 486 nm, and 436 nm after passing through the camera optical lens 40 according to the fourth embodiment. FIG. 16 shows field curvature and distortion of the light at a wavelength of 546 nm after passing through the camera optical lens 40 according to the fourth embodiment. In FIG. 16, the field curvature S is a field curvature in a sagittal direction, and T is a field curvature in a meridional direction.

In this embodiment, the entrance pupil diameter ENPD of the camera optical lens 40 is 4.323 mm, the image height IH at the 1.0 field of view is 6.986 mm, the field of view FOV at the 1.0 field of view is 89.32°, the image height IHm at the MIC field of view is 7.068 mm, and the field of view FOVm at the MIC field of view is 89.83°. The camera optical lens 40 meets the design requirements of large aperture, wide-angle and ultra-thin, effectively correcting both the on-axis and off-axis chromatic aberrations thereof, and has excellent optical characteristics.

### Fifth Embodiment

The meaning of the reference signs of the fifth embodiment is the same as that of the first embodiment.

FIG. 17 shows a camera optical lens 50 according to the fifth embodiment of the present disclosure.

Table 9 and Table 10 show design data of the camera optical lens 50 according to the fifth embodiment of the present disclosure.

TABLE 9

| | R | d | | nd | | vd | |
|---|---|---|---|---|---|---|---|
| S1 | ∞ | d0 = | −1.010 | | | | |
| R1 | 3.052 | d1 = | 1.208 | nd1 | 1.4959 | v1 | 81.64 |
| R2 | 10.947 | d2 = | 0.410 | | | | |
| R3 | 14.623 | d3 = | 0.224 | nd2 | 1.6797 | v2 | 17.05 |
| R4 | 8.055 | d4 = | 0.183 | | | | |
| R5 | 8.876 | d5 = | 0.299 | nd3 | 1.6797 | v3 | 17.05 |
| R6 | 10.418 | d6 = | 0.429 | | | | |
| R7 | −133.653 | d7 = | 0.685 | nd4 | 1.5444 | v4 | 55.82 |
| R8 | −14.228 | d8 = | 0.362 | | | | |
| R9 | −30.534 | d9 = | 0.418 | nd5 | 1.6700 | v5 | 19.39 |
| R10 | 71.935 | d10 = | 0.394 | | | | |
| R11 | 22.750 | d11 = | 0.603 | nd6 | 1.5661 | v6 | 37.71 |
| R12 | 15.051 | d12 = | 0.351 | | | | |
| R13 | 2.591 | d13 = | 0.607 | nd7 | 1.5346 | v7 | 55.69 |
| R14 | 6.724 | d14 = | 1.216 | | | | |
| R15 | −3.220 | d15 = | 0.442 | nd8 | 1.5346 | v8 | 55.69 |
| R16 | 14.422 | d16 = | 0.913 | | | | |
| R15 | ∞ | d17 = | 0.210 | ndg | 1.5168 | vg | 64.17 |
| R16 | ∞ | d18 = | 0.081 | | | | |

Table 10 shows aspheric data of each lens in the camera optical lens 50 according to the fifth embodiment of the present disclosure.

TABLE 10

| | Conic Coefficient | Aspheric Coefficient | | | | |
|---|---|---|---|---|---|---|
| | k | A4 | A6 | A8 | A10 | A12 |
| R1 | −6.3274E−01 | 1.6545E−03 | 1.6043E−03 | −1.4633E−03 | 9.4221E−04 | −3.8263E−04 |
| R2 | 3.0973E+00 | −2.4531E−03 | 4.9897E−04 | −6.7415E−04 | 5.8769E−04 | −3.0124E−04 |
| R3 | 1.2477E+01 | −5.0990E−03 | 3.2207E−03 | −5.5580E−03 | 1.1231E−02 | −1.4954E−02 |
| R4 | 1.5300E+01 | −7.5542E−03 | −7.4089E−03 | 2.8875E−02 | −6.5997E−02 | 1.0046E−01 |
| R5 | −5.5316E+01 | −2.8585E−03 | 4.0353E−03 | −3.4414E−02 | 8.5816E−02 | −1.3852E−01 |
| R6 | −5.2631E+01 | −3.5229E−03 | −1.5188E−03 | −5.6134E−03 | 2.1414E−02 | −4.8678E−02 |
| R7 | 5.9418E+02 | −1.4077E−02 | 3.6856E−02 | −1.7265E−01 | 4.6292E−01 | −8.2235E−01 |
| R8 | −2.6913E+01 | −9.1608E−03 | −7.1655E−03 | 1.9675E−03 | 4.8763E−03 | −1.4557E−02 |
| R9 | 1.0746E+02 | −4.8704E−03 | −5.0829E−03 | −2.2576E−02 | 5.0069E−02 | −5.8841E−02 |
| R10 | 6.5027E+02 | 6.0351E−04 | −1.1847E−02 | −2.5375E−03 | 1.2291E−02 | −1.3448E−02 |
| R11 | 4.1296E+01 | −1.0360E−02 | 6.5499E−03 | −4.2452E−03 | 1.5294E−03 | −3.3732E−04 |
| R12 | −6.7501E+01 | −6.4332E−02 | 2.7518E−02 | −7.8976E−03 | 1.6798E−03 | −4.4923E−04 |
| R13 | −7.6410E−01 | −3.3275E−02 | −2.9589E−03 | 3.2859E−03 | −1.5317E−03 | 4.4080E−04 |
| R14 | 4.3115E−01 | 3.9668E−02 | −2.9372E−02 | 1.1036E−02 | −2.9723E−03 | 5.9062E−04 |
| R15 | −1.1851E+01 | −2.3966E−02 | 3.7569E−03 | −6.8837E−04 | 4.1349E−04 | −1.2419E−04 |
| R16 | 3.3542E+00 | −6.6897E−03 | −3.8131E−03 | 1.9194E−03 | −4.8679E−04 | 8.1755E−05 |
| | k | A14 | A16 | A18 | A20 | A22 |
| R1 | −6.3274E−01 | 9.8815E−05 | −1.5774E−05 | 1.4240E−06 | −5.5905E−08 | −4.0098E−12 |
| R2 | 3.0973E+00 | 9.3202E−05 | −1.7212E−05 | 1.7507E−06 | −7.5634E−08 | −4.3011E−10 |
| R3 | 1.2477E+01 | 1.4146E−02 | −9.8510E−03 | 5.0952E−03 | −1.9460E−03 | 5.3902E−04 |
| R4 | 1.5300E+01 | −1.0624E−01 | 8.0062E−02 | −4.3653E−02 | 1.7288E−02 | −4.9328E−03 |
| R5 | −5.5316E+01 | 1.5555E−01 | −1.2470E−01 | 7.2235E−02 | −3.0269E−02 | 9.0770E−03 |
| R6 | −5.2631E+01 | 7.4040E−02 | −7.7559E−02 | 5.7166E−02 | −2.9888E−02 | 1.1023E−02 |
| R7 | 5.9418E+02 | 1.0100E+00 | −8.8119E−01 | 5.5382E−01 | −2.5144E−01 | 8.1690E−02 |
| R8 | −2.6913E+01 | 2.0312E−02 | −1.7835E−02 | 1.0582E−02 | −4.3529E−03 | 1.2454E−03 |
| R9 | 1.0746E+02 | 4.5785E−02 | −2.4911E−02 | 9.6748E−03 | −2.6957E−03 | 5.3465E−04 |
| R10 | 6.5027E+02 | 9.0759E−03 | −4.2053E−03 | 1.3772E−03 | −3.2127E−04 | 5.3050E−05 |
| R11 | 4.1296E+01 | 1.9336E−05 | 2.4228E−05 | −1.2963E−05 | 3.4264E−06 | −5.3480E−07 |
| R12 | −6.7501E+01 | 1.8274E−04 | −5.8731E−05 | 1.1961E−05 | −1.5389E−06 | 1.2564E−07 |
| R13 | −7.6410E−01 | −8.7460E−05 | 1.2536E−05 | −1.3031E−06 | 9.7223E−08 | −5.1211E−09 |
| R14 | 4.3115E−01 | −8.6783E−05 | 9.4418E−06 | −7.6115E−07 | 4.5255E−08 | −1.9560E−09 |
| R15 | −1.1851E+01 | 2.0423E−05 | −2.1269E−06 | 1.5061E−07 | −7.4778E−09 | 2.6172E−10 |
| R16 | 3.3542E+00 | −9.7527E−06 | 8.4504E−07 | −5.3432E−08 | 2.4539E−09 | −8.0713E−11 |

| | k | A24 | A26 | A28 | A30 |
|---|---|---|---|---|---|
| R1 | −6.3274E−01 | −2.0625E−12 | −1.1525E−12 | −7.0086E−13 | 1.2704E−13 |
| R2 | 3.0973E+00 | 8.1628E−11 | −9.5984E−12 | 7.0129E−13 | 1.0218E−13 |
| R3 | 1.2477E+01 | −1.0482E−04 | 1.3517E−05 | −1.0348E−06 | 3.5532E−08 |
| R4 | 1.5300E+01 | 9.8969E−04 | −1.3273E−04 | 1.0702E−05 | −3.9278E−07 |
| R5 | −5.5316E+01 | −1.8971E−03 | 2.6218E−04 | −2.1511E−05 | 7.9264E−07 |
| R6 | −5.2631E+01 | −2.8038E−03 | 4.6793E−04 | −4.6112E−05 | 2.0332E−06 |
| R7 | 5.9418E+02 | −1.8515E−02 | 2.7798E−03 | −2.4841E−04 | 1.0001E−05 |
| R8 | −2.6913E+01 | −2.4347E−04 | 3.1041E−05 | −2.3270E−06 | 7.7828E−08 |
| R9 | 1.0746E+02 | −7.3677E−05 | 6.7054E−06 | −3.6238E−07 | 8.8053E−09 |
| R10 | 6.5027E+02 | −6.0601E−06 | 4.5561E−07 | −2.0282E−08 | 4.0501E−10 |
| R11 | 4.1296E+01 | 4.9730E−08 | −2.5496E−09 | 5.5490E−11 | 4.0493E−16 |
| R12 | −6.7501E+01 | −6.3314E−09 | 1.8003E−10 | −2.2130E−12 | −2.8643E−18 |
| R13 | −7.6410E−01 | 1.8528E−10 | −4.3750E−12 | 6.0683E−14 | −3.7494E−16 |
| R14 | 4.3115E−01 | 5.9659E−11 | −1.2147E−12 | 1.4787E−14 | −8.1251E−17 |
| R15 | −1.1851E+01 | −6.3443E−12 | 1.0157E−13 | −9.6699E−16 | 4.1488E−18 |
| R16 | 3.3542E+00 | 1.8491E−12 | −2.7986E−14 | 2.5133E−16 | −1.0136E−18 |

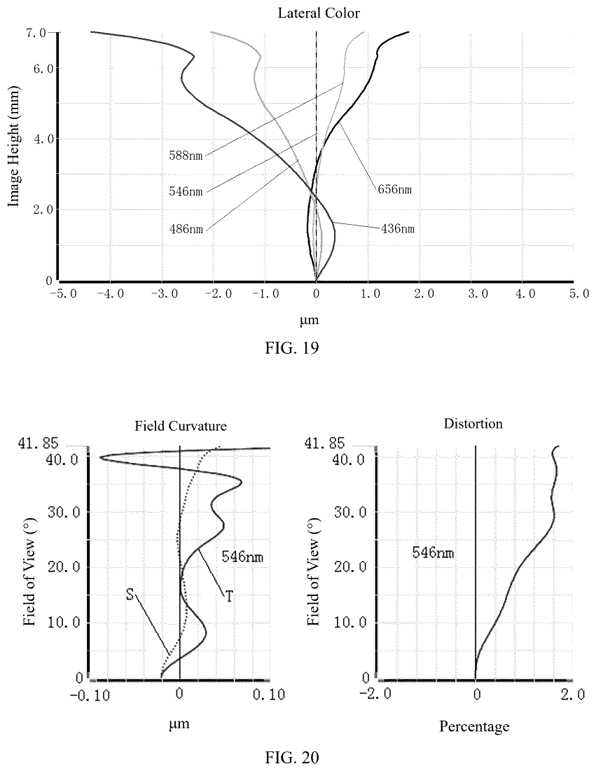

FIG. 18 and FIG. 19 respectively show longitudinal aberration and lateral color of the light at wavelengths of 656 nm, 588 nm, 546 nm, 486 nm, and 436 nm after passing through the camera optical lens 50 according to the fifth embodiment. FIG. 20 shows field curvature and distortion of the light at a wavelength of 546 nm after passing through the camera optical lens 50 according to the fifth embodiment. In FIG. 20, the field curvature S is a field curvature in a sagittal direction, and T is a field curvature in a meridional direction.

In this embodiment, the entrance pupil diameter ENPD of the camera optical lens 50 is 4.740 mm, the image height IH at the 1.0 field of view is 6.994 mm, the field of view FOV at the 1.0 field of view is 83.70°, the image height IHm at the MIC field of view is 7.095 mm, and the field of view FOVm at the MIC field of view is 84.40°. The camera optical lens 50 meets the design requirements of large aperture, wide-angle and ultra-thin, effectively correcting both the on-axis and off-axis chromatic aberrations thereof, and has excellent optical characteristics.

Table 13 shows values of various values in the first, second, third, fourth and fifth embodiments corresponding to parameters specified in the relational expressions.

### Comparative Embodiment

The meaning of the reference signs of the comparative embodiment is the same as that of the first embodiment.

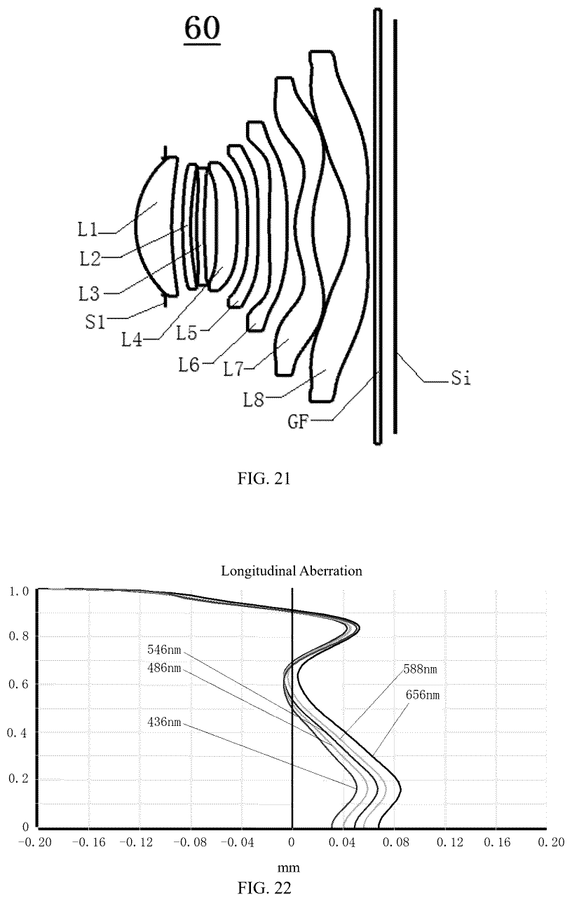

FIG. 21 shows a camera optical lens 60 according to the comparative embodiment.

Table 11 and Table 12 show design data of the camera optical lens 60 according to the comparative embodiment.

TABLE 11

| | R | d | | nd | | vd | |
|---|---|---|---|---|---|---|---|
| S1 | ∞ | d0 = | −0.996 | | | | |
| R1 | 3.026 | d1 = | 1.216 | nd1 | 1.4959 | v1 | 81.64 |
| R2 | 10.580 | d2 = | 0.370 | | | | |
| R3 | 13.533 | d3 = | 0.272 | nd2 | 1.6797 | v2 | 17.05 |
| R4 | 8.238 | d4 = | 0.197 | | | | |
| R5 | 8.870 | d5 = | 0.255 | nd3 | 1.6797 | v3 | 17.05 |
| R6 | 10.193 | d6 = | 0.419 | | | | |
| R7 | −238.030 | d7 = | 0.707 | nd4 | 1.5444 | v4 | 55.82 |
| R8 | −14.660 | d8 = | 0.348 | | | | |
| R9 | −31.846 | d9 = | 0.343 | nd5 | 1.6700 | v5 | 19.39 |
| R10 | 67.860 | d10 = | 0.387 | | | | |
| R11 | 22.654 | d11 = | 0.595 | nd6 | 1.5661 | v6 | 37.71 |
| R12 | 13.812 | d12 = | 0.277 | | | | |
| R13 | 2.569 | d13 = | 0.602 | nd7 | 1.5346 | v7 | 55.69 |
| R14 | 6.038 | d14 = | 1.230 | | | | |
| R15 | −3.674 | d15 = | 0.592 | nd8 | 1.5346 | v8 | 55.69 |
| R16 | 11.894 | d16 = | 0.277 | | | | |
| R15 | ∞ | d17 = | 0.210 | ndg | 1.5168 | vg | 64.17 |
| R16 | ∞ | d18 = | 0.495 | | | | |

Table 12 shows aspheric data of each lens in the camera optical lens 60 according to the comparative embodiment.

TABLE 12

| | Conic Coefficient | Aspheric Coefficient | | | | |
|---|---|---|---|---|---|---|
| | k | A4 | A6 | A8 | A10 | A12 |
| R1 | −6.6079E−01 | 2.1564E−03 | 1.5857E−03 | −1.4627E−03 | 9.4377E−04 | −3.8270E−04 |
| R2 | 2.9491E+00 | −2.8039E−03 | 6.1647E−04 | −6.8590E−04 | 5.8864E−04 | −3.0062E−04 |
| R3 | 1.2458E+01 | −5.3850E−03 | 3.1089E−03 | −5.5920E−03 | 1.1225E−02 | −1.4947E−02 |
| R4 | 1.5427E+01 | −7.1092E−03 | −7.4340E−03 | 2.8948E−02 | −6.6017E−02 | 1.0046E−01 |
| R5 | −4.9896E+01 | −2.9292E−03 | 4.0695E−03 | −3.4466E−02 | 8.5783E−02 | −1.3852E−01 |
| R6 | −3.9110E+01 | −3.5685E−03 | −1.9870E−03 | −5.5329E−03 | 2.1383E−02 | −4.8684E−02 |
| R7 | −9.9859E+02 | −1.3675E−02 | 3.7276E−02 | −1.7267E−01 | 4.6291E−01 | −8.2235E−01 |
| R8 | −4.5694E+01 | −9.3727E−03 | −6.2418E−03 | 1.5051E−03 | 5.0171E−03 | −1.4548E−02 |
| R9 | 8.0917E+01 | −4.3668E−03 | −4.9241E−03 | −2.2577E−02 | 5.0067E−02 | −5.8840E−02 |
| R10 | 2.9453E+02 | −2.4635E−04 | −1.0313E−02 | −3.2488E−03 | 1.2483E−02 | −1.3475E−02 |
| R11 | 3.0591E+01 | −9.9218E−03 | 6.6150E−03 | −4.2527E−03 | 1.5286E−03 | −3.3728E−04 |
| R12 | −5.7443E+01 | −6.4366E−02 | 2.7530E−02 | −7.8977E−03 | 1.6797E−03 | −4.4923E−04 |
| R13 | −7.6578E−01 | −3.3164E−02 | −2.9627E−03 | 3.2859E−03 | −1.5317E−03 | 4.4080E−04 |
| R14 | 3.6660E−01 | 3.9087E−02 | −2.9367E−02 | 1.1036E−02 | −2.9723E−03 | 5.9062E−04 |
| R15 | −1.2397E+01 | −2.3956E−02 | 3.7596E−03 | −6.8833E−04 | 4.1349E−04 | −1.2419E−04 |
| R16 | 2.9723E+00 | −6.9008E−03 | −3.8152E−03 | 1.9192E−03 | −4.8679E−04 | 8.1755E−05 |
| | k | A14 | A16 | A18 | A20 | A22 |
| R1 | −6.6079E−01 | 9.8786E−05 | −1.5777E−05 | 1.4239E−06 | −5.5901E−08 | 1.4159E−11 |
| R2 | 2.9491E+00 | 9.3105E−05 | −1.7226E−05 | 1.7491E−06 | −7.4666E−08 | 6.6680E−11 |
| R3 | 1.2458E+01 | 1.4147E−02 | −9.8512E−03 | 5.0952E−03 | −1.9460E−03 | 5.3903E−04 |
| R4 | 1.5427E+01 | −1.0624E−01 | 8.0062E−02 | −4.3653E−02 | 1.7288E−02 | −4.9328E−03 |
| R5 | −4.9896E+01 | 1.5555E−01 | −1.2470E−01 | 7.2235E−02 | −3.0268E−02 | 9.0770E−03 |
| R6 | −3.9110E+01 | 7.4036E−02 | −7.7557E−02 | 5.7166E−02 | −2.9888E−02 | 1.1023E−02 |
| R7 | −9.9859E+02 | 1.0101E+00 | −8.8119E−01 | 5.5382E−01 | −2.5144E−01 | 8.1690E−02 |
| R8 | −4.5694E+01 | 2.0300E−02 | −1.7833E−02 | 1.0582E−02 | −4.3529E−03 | 1.2454E−03 |
| R9 | 8.0917E+01 | 4.5785E−02 | −2.4911E−02 | 9.6749E−03 | −2.6957E−03 | 5.3465E−04 |
| R10 | 2.9453E+02 | 9.0775E−03 | −4.2053E−03 | 1.3772E−03 | −3.2127E−04 | 5.3050E−05 |
| R11 | 3.0591E+01 | 1.9361E−05 | 2.4228E−05 | −1.2963E−05 | 3.4264E−06 | −5.3480E−07 |
| R12 | −5.7443E+01 | 1.8274E−04 | −5.8731E−05 | 1.1961E−05 | −1.5389E−06 | 1.2564E−07 |
| R13 | −7.6578E−01 | −8.7460E−05 | 1.2536E−05 | −1.3031E−06 | 9.7223E−08 | −5.1211E−09 |
| R14 | 3.6660E−01 | −8.6783E−05 | 9.4418E−06 | −7.6115E−07 | 4.5255E−08 | −1.9560E−09 |
| R15 | −1.2397E+01 | 2.0423E−05 | −2.1269E−06 | 1.5061E−07 | −7.4778E−09 | 2.6172E−10 |
| R16 | 2.9723E+00 | −9.7527E−06 | 8.4504E−07 | −5.3432E−08 | 2.4539E−09 | −8.0713E−11 |

| | k | A24 | A26 | A28 | A30 |
|---|---|---|---|---|---|
| R1 | −6.6079E−01 | 4.4074E−12 | 1.3813E−14 | −3.5560E−14 | −1.0116E−14 |
| R2 | 2.9491E+00 | 1.7970E−11 | −7.3749E−13 | −5.7736E−13 | −4.1480E−13 |
| R3 | 1.2458E+01 | −1.0482E−04 | 1.3517E−05 | −1.0348E−06 | 3.5517E−08 |
| R4 | 1.5427E+01 | 9.8969E−04 | −1.3273E−04 | 1.0702E−05 | −3.9284E−07 |
| R5 | −4.9896E+01 | −1.8971E−03 | 2.6218E−04 | −2.1511E−05 | 7.9274E−07 |
| R6 | −3.9110E+01 | −2.8038E−03 | 4.6793E−04 | −4.6113E−05 | 2.0335E−06 |
| R7 | −9.9859E+02 | −1.8515E−02 | 2.7798E−03 | −2.4841E−04 | 1.0001E−05 |
| R8 | −4.5694E+01 | −2.4347E−04 | 3.1041E−05 | −2.3270E−06 | 7.7830E−08 |
| R9 | 8.0917E+01 | −7.3677E−05 | 6.7054E−06 | −3.6238E−07 | 8.8052E−09 |
| R10 | 2.9453E+02 | −6.0601E−06 | 4.5561E−07 | −2.0282E−08 | 4.0498E−10 |
| R11 | 3.0591E+01 | 4.9730E−08 | −2.5496E−09 | 5.5491E−11 | −4.6028E−17 |
| R12 | −5.7443E+01 | −6.3314E−09 | 1.8003E−10 | −2.2130E−12 | −1.6726E−19 |
| R13 | −7.6578E−01 | 1.8528E−10 | −4.3750E−12 | 6.0683E−14 | −3.7494E−16 |
| R14 | 3.6660E−01 | 5.9659E−11 | −1.2147E−12 | 1.4787E−14 | −8.1252E−17 |
| R15 | −1.2397E+01 | −6.3443E−12 | 1.0157E−13 | −9.6699E−16 | 4.1488E−18 |
| R16 | 2.9723E+00 | 1.8491E−12 | −2.7986E−14 | 2.5133E−16 | −1.0136E−18 |

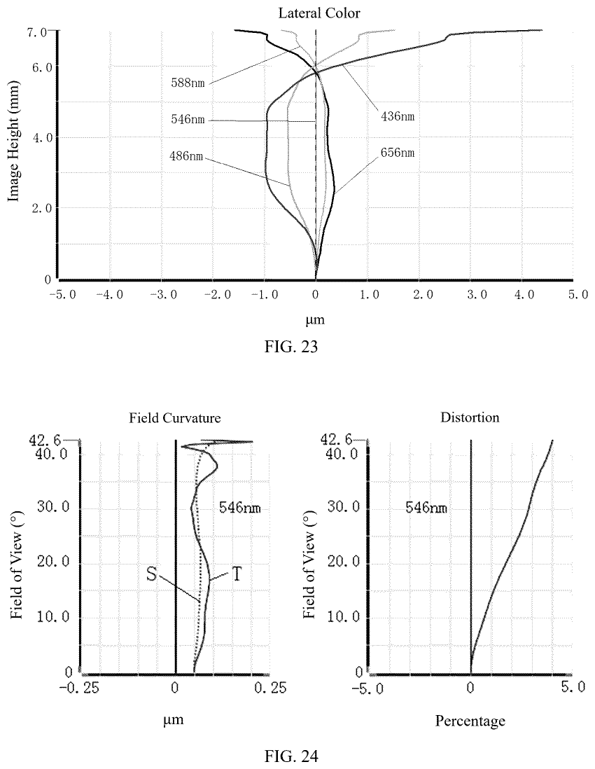

FIG. 22 and FIG. 23 respectively show longitudinal aberration and lateral color of the light at wavelengths of 656 nm, 588 nm, 546 nm, 486 nm, and 436 nm after passing through the camera optical lens 60 according to the comparative embodiment. FIG. 24 shows field curvature and distortion of the light at a wavelength of 546 nm after passing through the camera optical lens 60 according to the comparative embodiment. In FIG. 24, the field curvature S is a field curvature in a sagittal direction, and T is a field curvature in a meridional direction.

Table 13 below lists values corresponding to each relational expression in the comparative embodiment according to the above relational expressions. It is appreciated that, the camera optical lens 60 of the comparative embodiment does not satisfy the above relational expression 0.12≤BF/TTL≤0.15.

In the comparative embodiment, the entrance pupil diameter ENPD of the camera optical lens 60 is 4.596 mm, the image height IH at the 1.0 field of view is 7.000 mm, the field of view FOV at the 1.0 field of view is 85.27°, the image height IHm at the MIC field of view is 7.115 mm, and the field of view FOVm at the MIC field of view is 86.63°. The camera optical lens 60 does not meet the design requirements of wide-angle and ultra-thin.

TABLE 13

| Parameters | | | | | | |
|---|---|---|---|---|---|---|
| and | | | | | | |
| Relational | Embodiment | Embodiment | Embodiment | Embodiment | Embodiment | Comparative |
| Expressions | 1 | 2 | 3 | 4 | 5 | Embodiment |
| f3/f4 | 3.695 | 2.009 | 7.993 | 4.283 | 2.775 | 3.221 |
| f7/R14- | −0.131 | −0.101 | −0.137 | −0.136 | −0.399 | −0.103 |
| f8/R15 | | | | | | |
| BF/TTL | 0.131 | 0.129 | 0.120 | 0.149 | 0.133 | 0.112 |
| f | 7.337 | 7.458 | 7.178 | 6.870 | 7.532 | 7.303 |
| f1 | 8.123 | 8.116 | 7.806 | 8.242 | 8.098 | 8.089 |
| f2 | −30.843 | −30.369 | −29.272 | −37.364 | −26.398 | −31.21 |
| f3 | 105.347 | 68.960 | 205.173 | 116.252 | 80.666 | 91.933 |
| f4 | 28.509 | 34.320 | 25.668 | 27.144 | 29.066 | 28.542 |
| f5 | −32.467 | −32.360 | −32.163 | −33.514 | −31.558 | −31.918 |
| f6 | −76.231 | −72.623 | −75.963 | −118.683 | −80.357 | −63.671 |
| f7 | 7.780 | 7.866 | 7.788 | 7.639 | 7.469 | 7.855 |
| f8 | −5.276 | −5.312 | −5.293 | −5.680 | −4.861 | −5.16 |
| FNO | 1.589 | 1.589 | 1.589 | 1.589 | 1.589 | 1.589 |
| TTL | 8.891 | 8.938 | 8.809 | 8.463 | 9.035 | 8.792 |
| IH | 7.000 | 6.947 | 6.792 | 6.986 | 6.994 | 7 |
| FOV | 85.27° | 84.33° | 85.00° | 89.32° | 83.70° | 85.27° |

Those skilled in the art should understand that the above embodiments are just specific embodiments for implementing the present disclosure, and in practical applications, various changes may be implemented in form and detail without departing from the spirit and scope of the present disclosure

What is claimed is:

1. A camera optical lens, comprising eight lenses from an object side to an image side:
a first lens having positive refractive power;
a second lens having negative refractive power;
a third lens having positive refractive power;
a fourth lens having positive refractive power;
a fifth lens having negative refractive power;
a sixth lens having negative refractive power;
a seventh lens having positive refractive power; and
an eighth lens having negative refractive power,
wherein a focal length of the third lens is f3, a focal length of the fourth lens is f4, a focal length of the seventh lens is f7, a focal length of the eighth lens is f8, a central curvature radius of an image side surface of the seventh lens is R14, a central curvature radius of an object side surface of the eighth lens is R15, a total track length of the camera optical lens is TTL, and an on-axis distance from an image side surface of the eighth lens to an image plane is BF, and following relational expressions are satisfied:
$$2. \leq f 3 / f 4 \leq 8. ;$$
$$- 0.4 \leq f 7 / R 14 - f 8 / R 15 \leq - 0.1 ; and$$
$$0.12 \leq BF / TTL \leq 0.15 .$$

2. The camera optical lens as described in claim 1, wherein a focal length of the camera optical lens is f, and a focal length of the second lens is f2, and a following relational expression is satisfied:
$$- 5.5 \leq f 2 / f \leq - 3.5 .$$

3. The camera optical lens as described in claim 1, wherein a focal length of the fifth lens is f5, a central curvature radius of an object side surface of the fifth lens is R9, a central curvature radius of an image side surface of the fifth lens is R10, and an on-axis thickness of the fifth lens is d9, and a following relational expression is satisfied:
$$0.06 \leq f 5 * d 9 / ( R 9 - R 10 ) \leq 0.13 .$$

4. The camera optical lens as described in claim 1, wherein an Abbe number of the first lens is v1, and a following relational expression is satisfied:
$$60. \leq v 1 \leq 82. .$$

5. The camera optical lens as described in claim 1, wherein an object side surface of the first lens is convex in a paraxial region, and an image side surface of the first lens is concave in the paraxial region, and
wherein a focal length of the camera optical lens is f, a focal length of the first lens is f1, a central curvature radius of the object side surface of the first lens is R1, a central curvature radius of the image side surface of the first lens is R2, and an on-axis thickness of the first lens is d1, and following relational expressions are satisfied:
$$1.07 \leq f 1 / f \leq 1.2 ;$$
$$- 1.85 \leq ( R 1 + R 2 ) / ( R 1 - R 2 ) \leq - 1.77 ; and$$
$$0.13 \leq d 1 / TTL \leq 0.134 .$$

6. The camera optical lens as described in claim 1, wherein an object side surface of the second lens is convex in a paraxial region, and an image side surface of the second lens is concave in the paraxial region, and
wherein a focal length of the camera optical lens is f, a central curvature radius of the object side surface of the second lens is R3, a central curvature radius of the image side surface of the second lens is R4, and an on-axis thickness of the second lens is d3, and following relational expressions are satisfied:
$$3.45 \leq ( R 3 + R 4 ) / ( R 3 - R 4 ) \leq 5. ; and$$
$$0.025 \leq d 3 / TTL \leq 0.034 .$$

7. The camera optical lens as described in claim 1, wherein an object side surface of the third lens is convex in a paraxial region, and an image side surface of the third lens is concave in the paraxial region, and
wherein a focal length of the camera optical lens is f, a central curvature radius of the object side surface of the third lens is R5, a central curvature radius of the image side surface of the third lens is R6, and an on-axis thickness of the third lens is d5, and following relational expressions are satisfied:
$$9.24 \leq f 3 / f \leq 28.59 ;$$
$$- 31.28 \leq ( R 5 + R 6 ) / ( R 5 - R 6 ) \leq - 10.24 ; and$$
$$0.026 \leq d 5 / TTL \leq 0.038 .$$

8. The camera optical lens as described in claim 1, wherein an object side surface of the fourth lens is concave in a paraxial region, and an image side surface of the fourth lens is convex in the paraxial region, and
wherein a focal length of the camera optical lens is f, a central curvature radius of the object side surface of the fourth lens is R7, a central curvature radius of the image side surface of the fourth lens is R8, and an on-axis thickness of the fourth lens is d7, and following relational expressions are satisfied:
$$3.57 \leq f 4 / f \leq 4.61 ;$$
$$1.13 \leq ( R 7 + R 8 ) / ( R 7 - R 8 ) \leq 1.56 ; and$$
$$0.075 \leq d 7 / TTL \leq 0.082 .$$

9. The camera optical lens as described in claim 1, wherein an object side surface of the fifth lens is concave in a paraxial region, and an image side surface of the fifth lens is concave in the paraxial region, and
wherein a focal length of the camera optical lens is f, a focal length of the fifth lens is f5, a central curvature radius of the object side surface of the fifth lens is R9, a central curvature radius of the image side surface of the fifth lens is R10, and an on-axis thickness of the fifth lens is d9, and following relational expressions are satisfied:
$$- 4.48 \leq f 5 / f \leq - 4.18 ;$$
$$- 0.7 \leq ( R 9 + R 10 ) / ( R 9 - R 10 ) \leq - 0.4 ; and$$
$$0.033 \leq d 9 / TTL \leq 0.047 .$$

10. The camera optical lens as described in claim 1, wherein an object side surface of the sixth lens is convex in a paraxial region, and an image side surface of the sixth lens is concave in the paraxial region, and
wherein a focal length of the camera optical lens is f, a focal length of the sixth lens is f6, a central curvature radius of the object side surface of the sixth lens is R11, a central curvature radius of the image side surface of the sixth lens is R12, and an on-axis thickness of the sixth lens is d11, and following relational expressions are satisfied:
$$- 17.28 \leq f 6 / f \leq - 9.73 ;$$
$$4.4 \leq ( R 11 + R 12 ) / ( R 11 - R 12 ) \leq 6.75 ; and$$
$$0.065 \leq d 11 / TTL \leq 0.069 .$$

11. The camera optical lens as described in claim 1, wherein an object side surface of the seventh lens is convex in a paraxial region, and the image side surface of the seventh lens is concave in the paraxial region, and
wherein a focal length of the camera optical lens is f, a central curvature radius of the object side surface of the seventh lens is R13, and an on-axis thickness of the seventh lens is d13, and following relational expressions are satisfied:
$$0.99 \leq f 7 / f \leq 1.12 ;$$
$$- 2.47 \leq ( R 13 + R 14 ) / ( R 13 - R 14 ) \leq - 2.25 ; and$$
$$0.062 \leq d 13 / TTL \leq 0.068 .$$

12. The camera optical lens as described in claim 1, wherein the object side surface of the eighth lens is concave in a paraxial region, and the image side surface of the eighth lens is concave in the paraxial region, and
wherein a focal length of the camera optical lens is f, a central curvature radius of the image side surface of the eighth lens is R16, and an on-axis thickness of the eighth lens is d15, and following relational expressions are satisfied:
$$- 0.83 \leq f 8 / f \leq - 0.64 ;$$
$$- 0.64 \leq ( R 15 + R 16 ) / ( R 15 - R 16 ) \leq - 0.48 ; and$$
$$0.048 \leq d 15 / TTL \leq 0.068 .$$

13. The camera optical lens as described in claim 1, wherein the first lens is made of glass.
